(19) United States
(12) Patent Application Publication
(10) Pub. No.: US 2024/0331024 A1
(43) Pub. Date: Oct. 3, 2024

(54) METHODS, SYSTEMS, AND DEVICES TO PROVIDE AN APARTMENT SEEKER WITH PRE-APPROVAL PRIOR TO APPLYING AND PAYING AN APPLICATION FEE TO A RENTAL COMMUNITY

(71) Applicant: EDST, LLC, Lubbock, TX (US)

(72) Inventors: Shawn C. Massie, Lubbock, TX (US); David P. Marcinkowski, Lubbock, TX (US)

(73) Assignee: EDST, LLC., Lubbock, TX (US)

(21) Appl. No.: 18/620,121

(22) Filed: Mar. 28, 2024

Related U.S. Application Data
(60) Provisional application No. 63/492,609, filed on Mar. 28, 2023.

(51) Int. Cl. G06Q 30/0645; G06F 21/32

(52) U.S. Cl. CPC G06Q 30/0645; G06F 21/32

(57) ABSTRACT

Aspects of the subject disclosure may include, for example, obtaining, over a communication network, first lease application information from a first communication device associated with a user, determining that the first lease application information includes a first captured facial image of the user, and verifying an identity of the user utilizing image recognition techniques based on the first captured facial image resulting in a first identity verification. Further embodiments can include transmitting a first portion of the first lease application information to a first third party server, the first third party server processes the first portion of the first lease application information for application approval, and receiving application approval from the first third party server. Additional embodiments can include determining a group of rental communities that the user is approved to lease based on the first lease application information based on the application approval, and transmitting the group of rental communities to the first communication device, the first communication device presents the group of rental communities utilizing a mapping software application. Other embodiments are disclosed.

### CROSS-REFERENCE TO RELATED APPLICATION

This application claims the benefit of and priority to U.S. Provisional Ser. No. 63/492,609, filed Mar. 28, 2023. The contents of the foregoing are hereby incorporated by reference into this application as if set forth herein in full.

### FIELD OF THE DISCLOSURE

The subject of the disclosure relates to methods, systems, and devices to provide an apartment seeker with pre-approval prior to applying to and paying for an application to a rental community.

### BACKGROUND

Traditionally, an apartment seeker searching to rent an apartment needed to complete a physical paper rental application for each rental community they were interested in renting and proceed through an approval process with each rental community individually, which included payment of an application fee, to determine whether they were eligible to rent an apartment within each rental community. Further, while some rental communities have offered an electronic version of a physical paper application, it is still a manual process of entering all the information needed for approval and is not an automated process.

Further, a traditional lease application process has been unwieldy, time consuming, expensive and cumbersome. Moreover, it was often fraught with fraud and risk. Even in today's electronic/Internet driven society, millions of applications are processed each year in paper form. As noted above, in recent years, some rental communities shifted to electronic applications. However, these were typically simply paper forms presented in an electronic template format (e.g., fillable.pdf). The information contained in the electronic form still needed to be manually entered by the prospective tenant (hereinafter “user”). Further, verification/disclosure requirement of tenant information around Identity, Credit, Criminal History, and Eviction History was still required to be performed. Moreover, for many rental communities, additional information around Income Verification, Willingness to Pay Measures, Document Validation, and Employment Verification may be required. This could be further complicated as the exchange of payment was required to conclude the information gathering process and to start the actual screen process.

Because each form was tied to a specific rental community, if a user wanted to consider more than one rental community, or if the user failed to qualify for a first rental community and needed to apply at a second rental community, the user would need to manually re-enter all the lease application information over again and then remit additional payments to each rental community. In addition, in each case, the owner of the rental community would need an employee to process the lease application (whether submitted in person or sent electronically by such means as email). The time and effort from the user was significant and compounded by growing monetary costs. Further, the time and money expended by the property was significant. Also, fraud was not uncommon. Some rental communities leveraged third party providers that specialized in determining identity fraud by leveraging uniquely tailored questions to users, which resulted in discovery approximately 80% of the potentially fraudulent identity theft situations.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a system in accordance with various aspects described herein.

FIGS. 2A-2K depicts illustrative embodiments of methods in accordance with various aspects described herein.

FIGS. 2L-2Q are block diagrams illustrating exemplary, non-limiting embodiments of a system in accordance with various aspects described herein.

FIG. 3 is a block diagram of an example, non-limiting embodiment of a computing environment in accordance with various aspects described herein.

FIG. 4 is a block diagram of an example, non-limiting embodiment of a communication device in accordance with various aspects described herein.

### DETAILED DESCRIPTION

The subject disclosure describes, among other things, illustrative embodiments for obtaining, over a communication network, first lease application information from a first communication device associated with a user, determining that the first lease application information includes a first captured facial image of the user, and verifying an identity of the user utilizing image recognition techniques based on the first captured facial image resulting in a first identity verification. Further embodiments can include transmitting a first portion of the first lease application information to a first third party server, the first third party server processes the first portion of the first lease application information for application approval, and receiving the application approval from the first third party server. Additional embodiments can include determining a group of rental communities that the user is approved to lease based on the first lease application information and the application approval, and transmitting the group of rental communities to the first communication device, the first communication device presents the group of rental communities utilizing a mapping software application. Other embodiments are described in the subject disclosure.

One or more aspects of the subject disclosure include a device, comprising a processing system including a processor, and a memory that stores executable instructions that, when executed by the processing system, facilitate performance of operations. The operations can comprise obtaining, over a communication network, first lease application information from a first communication device associated with a user, determining that the first lease application information includes a first captured facial image of the user, and verifying an identity of the user utilizing image recognition techniques based on the first captured facial image resulting in a first identity verification. Further operations can comprise transmitting a first portion of the first lease application information to a first third party server, the first third party server processes the first portion of the first lease application information for application approval, and receiving the application approval from the first third party server. Additional operations can comprise determining a group of rental communities that the user is approved to lease based on the first lease application information and the application approval, and transmitting the group of rental communities to the first communication device, the first communication device presents the group of rental communities utilizing a mapping software application.

One or more aspects of the subject disclosure include a non-transitory machine-readable medium, comprising executable instructions that, when executed by a processing system including a processor, facilitate performance of operations. The operations can comprise obtaining, over a communication network, first lease application information from a first communication device associated with a user, determining that the first lease application information includes a first captured facial image of the user and verifying an identity of the user utilizing image recognition techniques based on the first captured facial image resulting in a first identity verification. Further operations can comprise transmitting a first portion of the first lease application information to a first third party server, the first third party server processes the first portion of the first lease application information for application approval, and receiving the application approval from the first third party server. Additional operations can comprise determining a group of rental communities that the user is approved to lease based on the first lease application information and the application approval, and transmitting the group of rental communities to the first communication device, the first communication device presents the group of rental communities utilizing a mapping software application.

One or more aspects of the subject disclosure include a method. The method can comprise obtaining, over a communication network, by a processing system including a processor, first lease application information from a first communication device associated with a user, determining, by the processing system, that the first lease application information includes a first captured facial image of the user, and verifying, by the processing system, an identity of the user utilizing image recognition techniques based on the first captured facial image resulting in a first identity verification. Further, the method can comprise transmitting, by the processing system, a first portion of the first lease application information to a first third party server, the first third party server processes the first portion of the first lease application information for application approval, and receiving, by the processing system, the application approval from the first third party server. In addition, the method can comprise determining, by the processing system, a group of rental communities that the user is approved to lease based on the first lease application information and the application approval, and transmitting, by the processing system, the group of rental communities to the first communication device, the first communication device presents the group of rental communities utilizing a mapping software application.

One or more aspects of the subject disclosure include a device, comprising a processing system including a processor, and a memory that stores executable instructions that, when executed by the processing system, facilitate performance of operations. The operations can comprise obtaining, over a communication network, first lease application information from a first communication device associated with a user, determining a first selected rental community based on the first lease application information, and determining that the first lease application information includes a first captured facial image of the user and a first group of captured images of an identification card. Further operations can comprise verifying an identity of the user utilizing image recognition techniques based on the first captured facial image and the first group of captured images of the identification card resulting in a first identity verification, transmitting a first portion of the first lease application information to a first third party server, wherein the first third party server processes the first portion of the first lease application information for application approval, and receiving the application approval from the first third party server. In addition, the operations can comprise determining that the user is approved to lease the first selected rental community based on the first lease application information and the application approval, and transmitting a notification to the first communication device indicating the application approval for the first selected rental community, wherein the first communication device presents notification.

One or more embodiments seek to solve the problems associated with manually processing a lease application to improve time, energy, cost and inefficiency. Moreover, the process creates greater certainty and reduces risk for the rental community. The process in its preferred embodiment is seamless and requires nothing more than a user creating an account on a software application (e.g., mobile application), which would require information such as name, cell phone number, and email address. Preferably, but not required, the user can also set up payment information for when a lease application is processed for approval.

In one or more embodiments, once an account is created, the user can leverage the efficiencies of software application. For example, assuming the user knows which rental community is of interest, they click on “Apply Now” on the webpage for rental community and discover that the rental community allows for submission through the software application (either by directing the user or requesting they download the software application). The user can then log into the software application for the selected rental community and select a desired unit to be processed and apply.

At that time, the software application can require the user to take a “selfie” image. In addition, the user can be required to take a picture of the user's driver's license (typically front and back) and conclude the ID verification process by answering uniquely tailored questions to the user. At that point, assuming the preferred embodiments and the payment information has been stored, the user need not enter any information again (other than checking some boxes) in the process until it is time to render payment for the lease application.

This is because in step 1 (Identity Verification), the software application can take the captured images and send them to a third-party service that would use them to assist in verifying the identity of the user. In addition, the software application can also leverage the user tailored questions to reinforce (or discover attempted fraud) the identity of the user, reducing the fraud incident rate significantly.

In step 2 (Criminal, Credit, Income/Employment and Eviction History), this Identity Verification third party service can have access to information associated with the driver's license of the user such that, without further input from the user, it could (or through providing the information to another third party service), verify the credit, criminal history, income/employment and eviction history of the user in nearly real-time. This process would be faster than being entered manually by a rental community owner after receipt of a user's application.

As more third party services are leveraged, more data is gathered, which can then allow the software application to leverage through the same or other third parties, verifications related to income, the willingness of a user to pay rent, and employment history. Again, rather than requiring the user to enter his/her employment history in the lease application, it is auto-populated in the lease application. So too are the other requested pieces/portions of information. So, it is not just that all these services can be run behind the scenes (out of view of the user), it is also the fact that the information gathered from these services (e.g., third party servers) are used to complete the lease application for the user automatically.

Because the rental community sets the minimum standards/requirements for these various screening issues, the software application can compare the results from its behind the scenes data gathering and let the user know if he/she qualifies to live in the rental community under consideration prior to the submission of a lease application or the submission of payment funds. If the only issue/limit relates to Credit or Income, the software application can allow the user to add a Guarantor or a roommate (e.g., with an acceptable credit score and/or income level). In this searching or preapproval embodiment, the user is free to evaluate their acceptance criteria and compare their individual screening results to any rental community for the next 30 days without the need to undergo further screening. All of this processing can be executed by the user without the knowledge or intervention of a potentially accepting rental community.

In the above example, the user has narrowed down his/her choice to a rental community. However, other embodiments can include the following. If the user decides to select a different rental community or does not qualify for the rental community at issue, he/she does not need to run the lease application process again. They simply select another property and the software application (as long as this is done within 30 days in some embodiments) can automatically verify if the user qualifies and completes the lease application.

If the user wants to view all rental communities he/she qualifies to rent on his/her own in a given area or all properties he/she can qualify for if credit or income were higher (guarantor/roommate addition), the software application can provide those options to the user on a map or drop down list format.

One or more embodiments described herein include the software and/or hardware modules and software processes that comprise methods, systems, and devices to provide an apartment secker with pre-approval prior to applying to and paying for an application to a rental community. The prospective apartment seeker/prospective tenant journey sequencing can be enabled through a user interface (UI)/user experience (UX) design. A module/process can be associated with an apartment seeker and/or property manager process with associated benefits.

One or more embodiments can improve prospective tenants lives by enabling them to: (1) avoid paying multiple application fees to see if they qualify for different rental communities; (2) save time by digitally completing a single application leveraging history and existing information, leasing, screening, and onboarding process that they can direct to the rental communities which they have been prequalified; (3) avoid frustration caused by not having all pre move-in activities standardized and contained to a single, digital workflow; and (4) put the gathering, transmission and control of apartment screening application data in the hand of the apartment seeker, ultimately allowing the apartment seeker to drive and control the process. Thus, embodiments described herein can lead to improved processes for apartment seekers to search for apartments in rental communities.

One or more embodiments can centralize and streamline the apartment leasing process by building a 100% (or significant portion) digital tenant qualification and onboarding lease service/application. This qualification and onboarding lease service/application can include platforms available from multiple service partners (e.g., third parties) to present a fully vetted prospective tenant to a rental community. Upon submission of the lease application, one or more embodiments can digitally manage the leasing workflow including apartment/unit selection, completion of the lease and consent forms, managing guarantor and co-tenant workflow, satisfaction of rental community specific on-boarding requirements, and facilitation of required payment to the rental community. For the apartment seeker, one or more embodiments allow for the completion of the application and lease process all without visiting the leasing office, and, in many cases, all without assistance or intervention from property staff. Thus, one or more embodiments can provide the apartment seeker with pre-approval prior to applying to and paying for an application fee to a rental community.

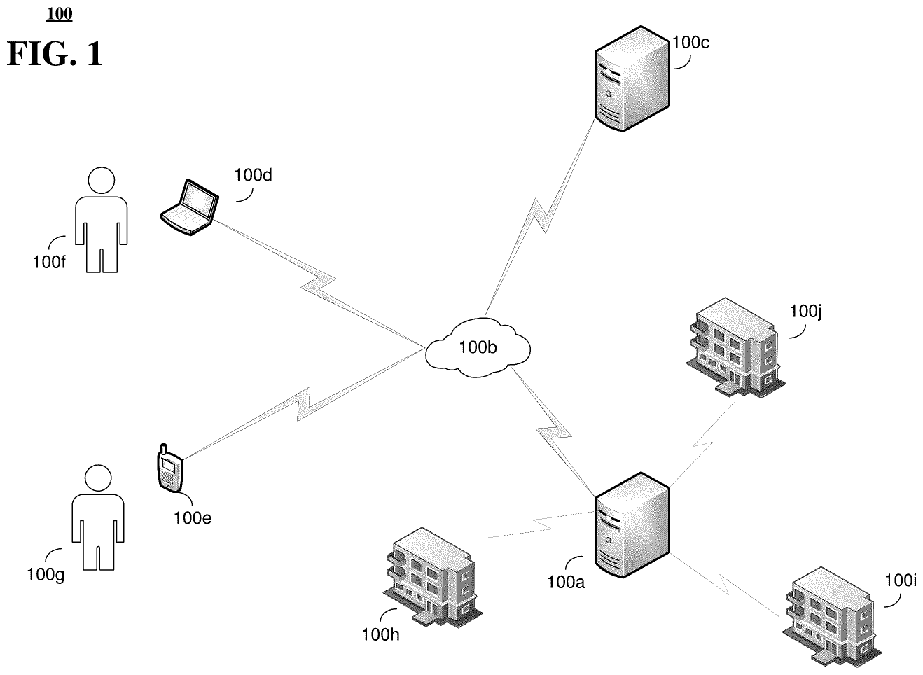

FIG. 1 is a block diagram illustrating an exemplary, non-limiting embodiment of a system 100 in accordance with various aspects described herein. In one or more embodiments, system 100 can include a server 100a communicatively coupled to a third party server 100c over communication network 100b as well as communicatively coupled to communication device 100d associated with user 100f and communication device 100c associated with user 100g. Communication network 100b can comprise one or more wireless communication networks, one or more wired communication networks, or a combination thereof. Each of server 100a and server 100c can comprise one or more servers in one location or spanning multiple locations, one or more virtual servers in one location or spanning multiple locations, and/or one or more cloud servers. Each of communication device 100d and communication device 100e can comprise, but are not limited to, a mobile phone, a smartphone, a mobile device, a laptop computer, tablet computer, a desktop computer, or any other computing device.

In one or more embodiments, user 100g can be an apartment seeker/prospective tenant for a rental community 100h (e.g., apartment complex, apartment building, rental house, etc.). Further, user 100g can download an apartment lease application associated with rental community 100h utilizing a software application provided by server 100a and complete the lease application. In addition, the process to complete the lease application utilizing the software application can include verifying the identity of user 100g using image recognition techniques. That is, the user 100g can capture a facial image of themselves using a camera coupled to communication device 100e and the facial image can be transmitted by communication device 100e to server 100a. Further, server 100a can transmit the facial image to third party server 100c that can compare the transmitted facial image with a stored facial image associated with user 100g in a public database (e.g., motor vehicle department database of driver's license facial images). After such a comparison, the third party can verify the identity (or not) of user 100g and provide a notification to server 100a accordingly.

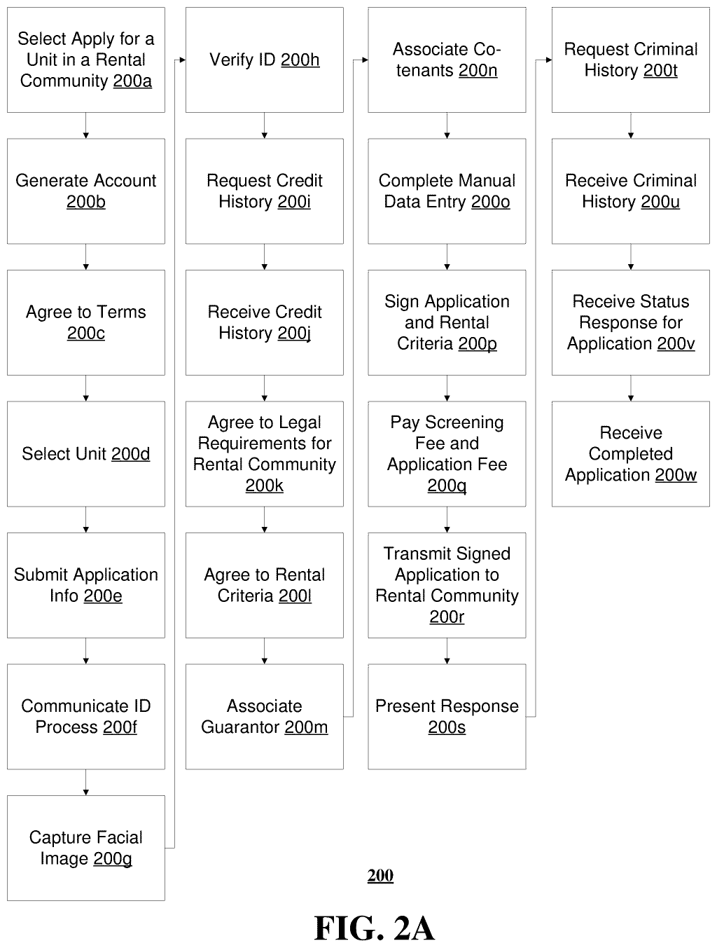

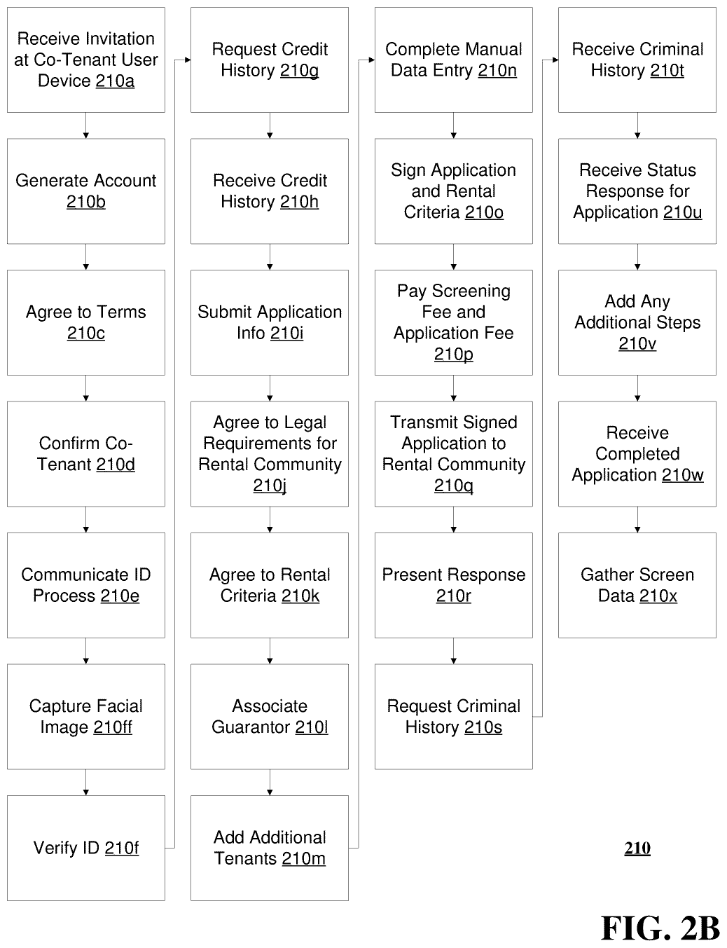

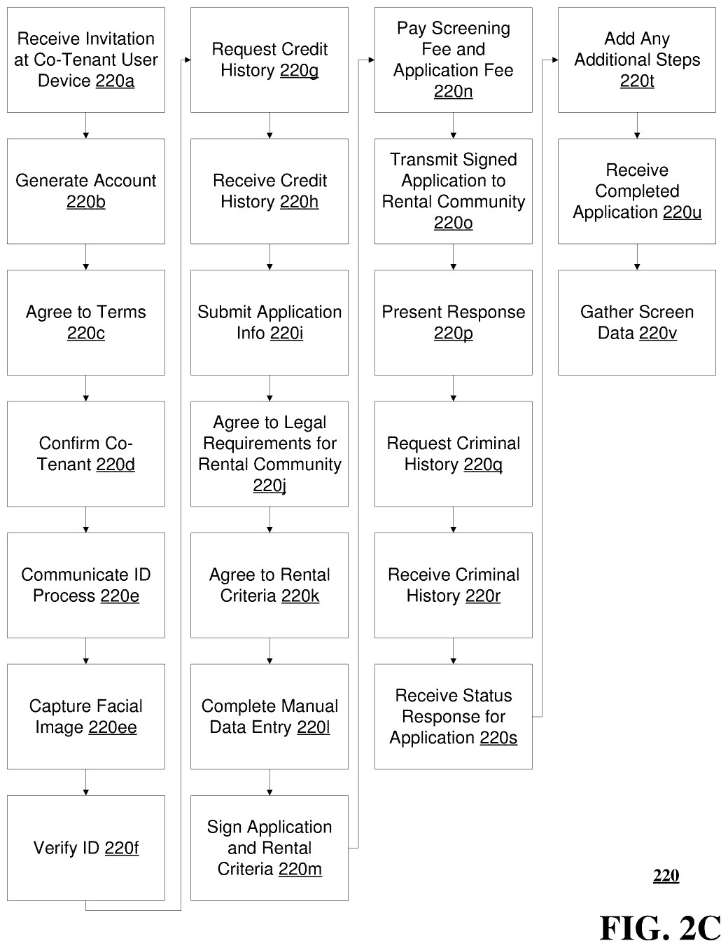

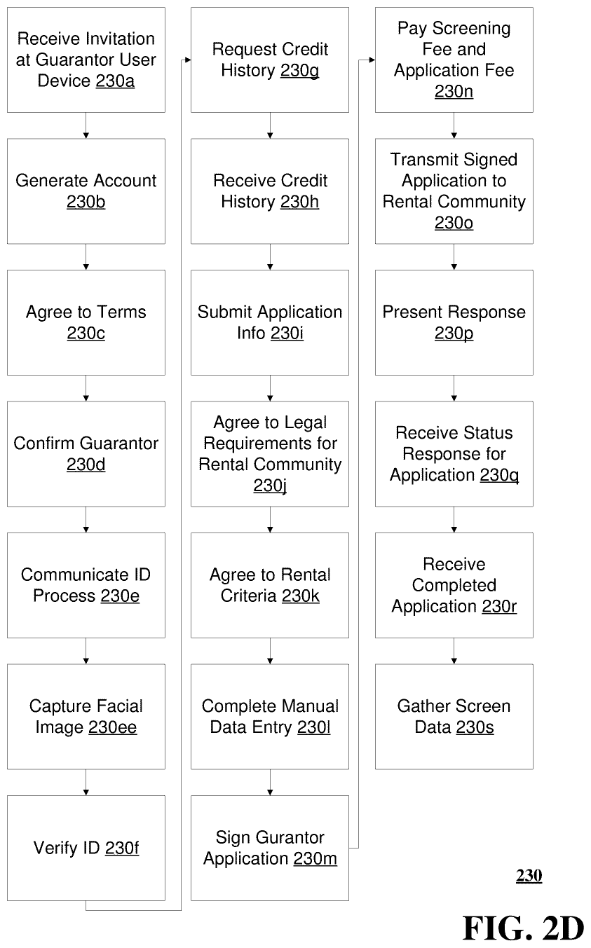

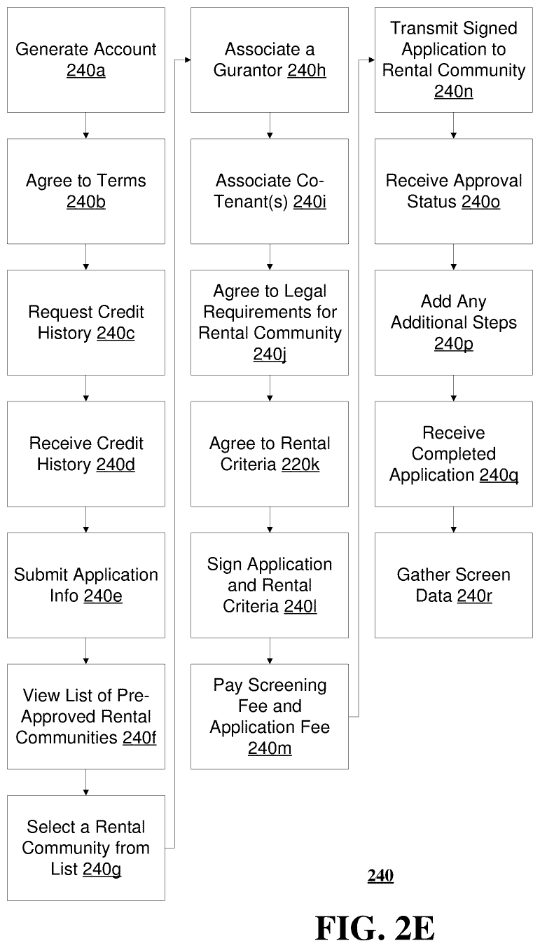

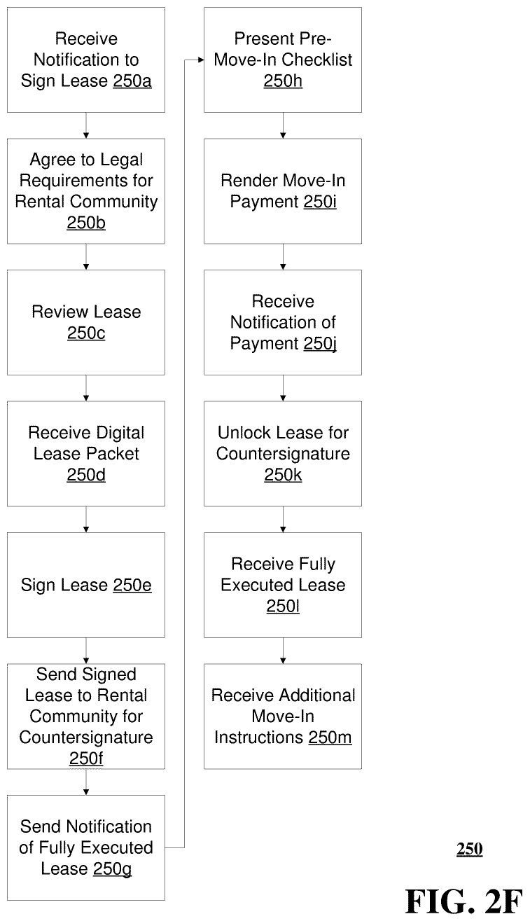

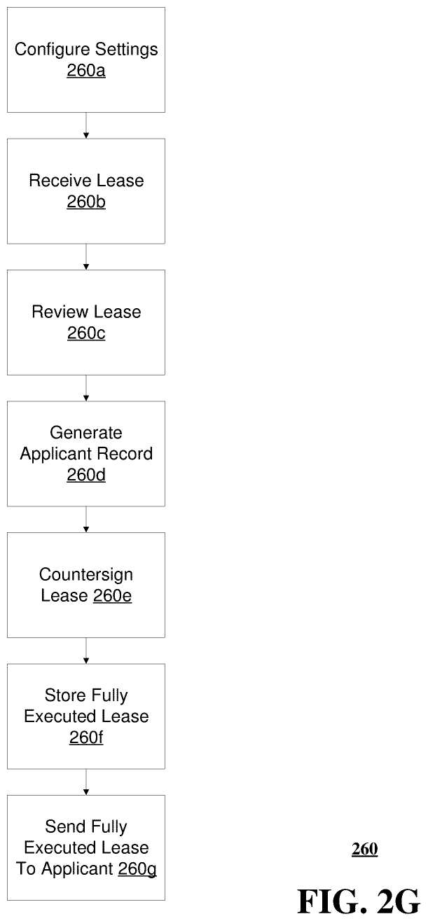

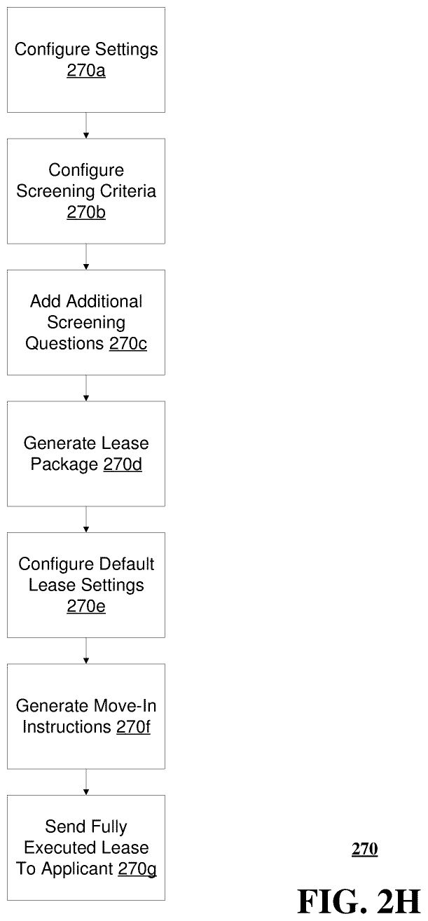

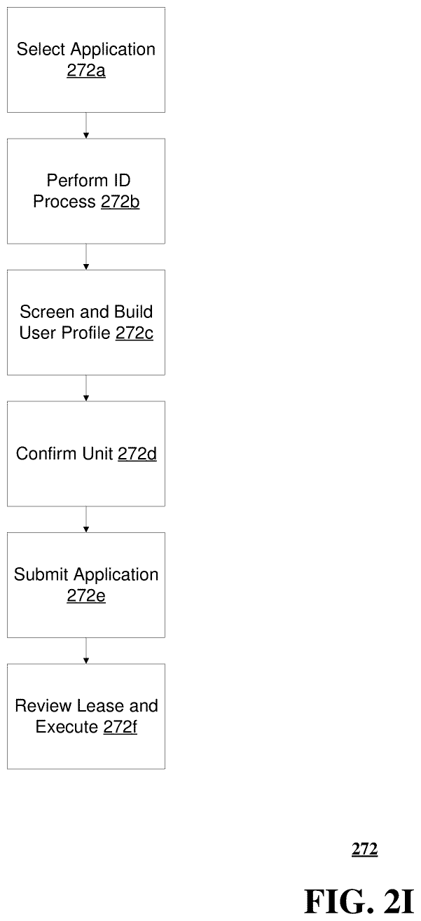

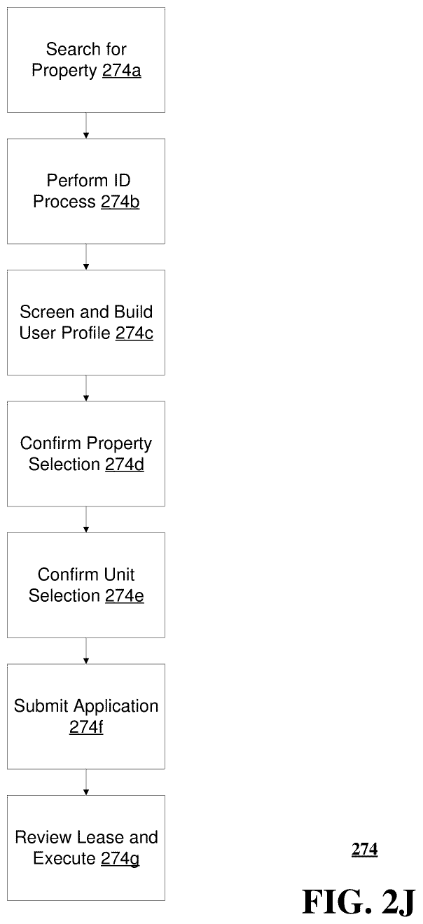

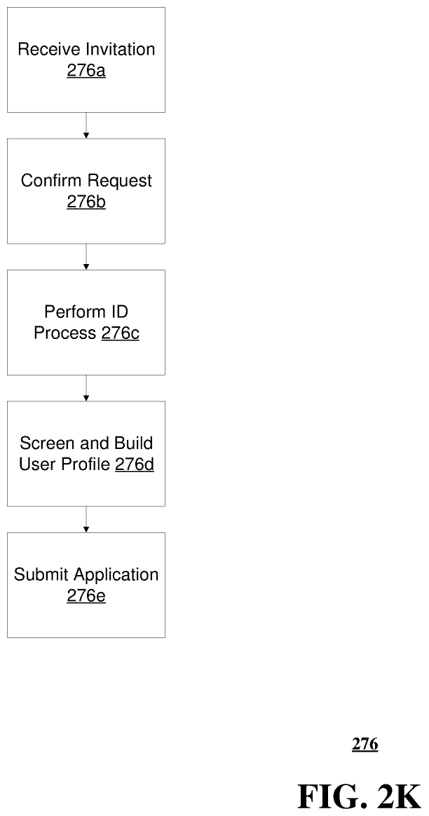

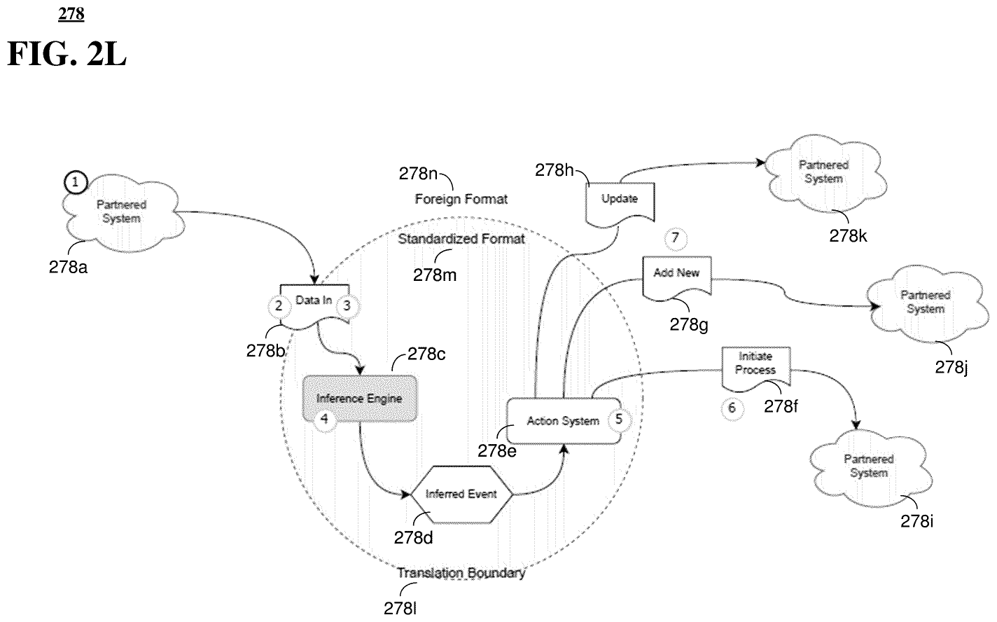

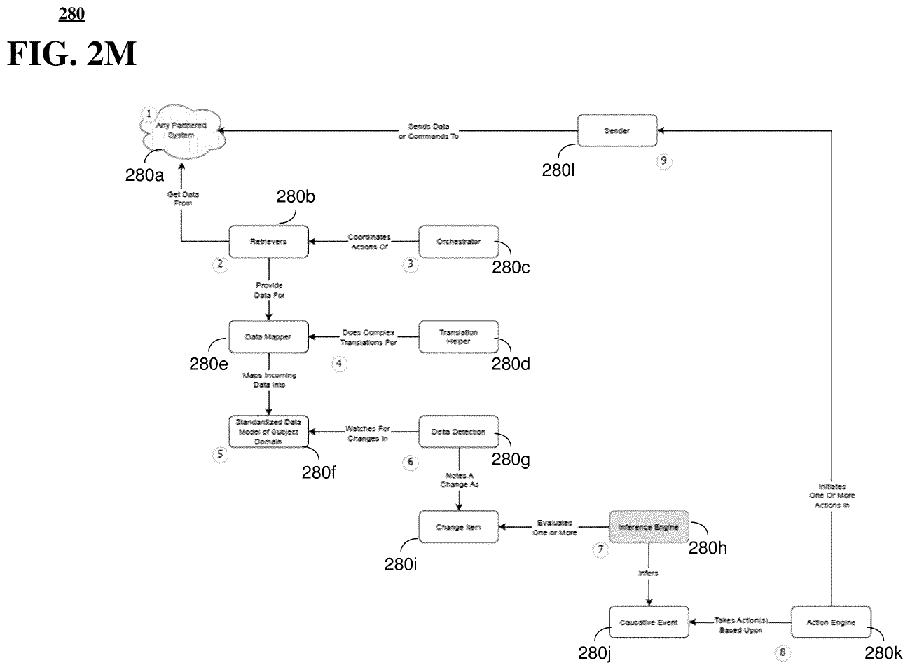

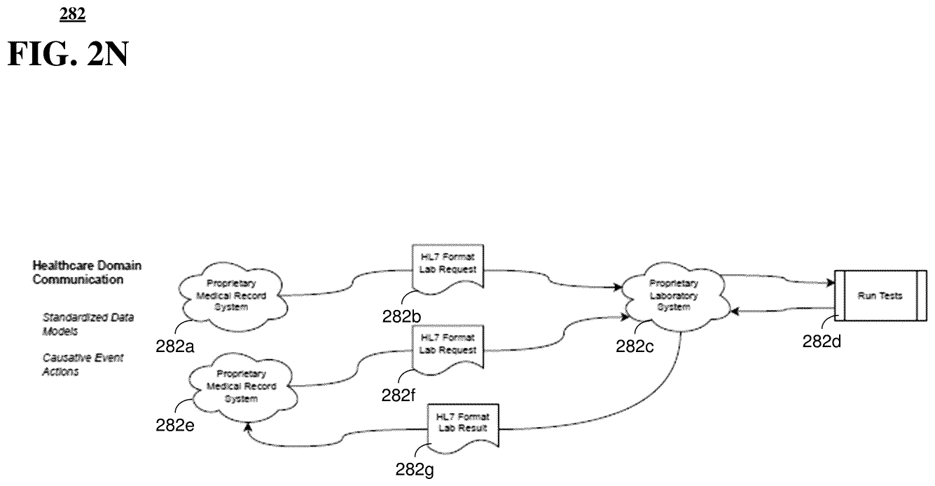

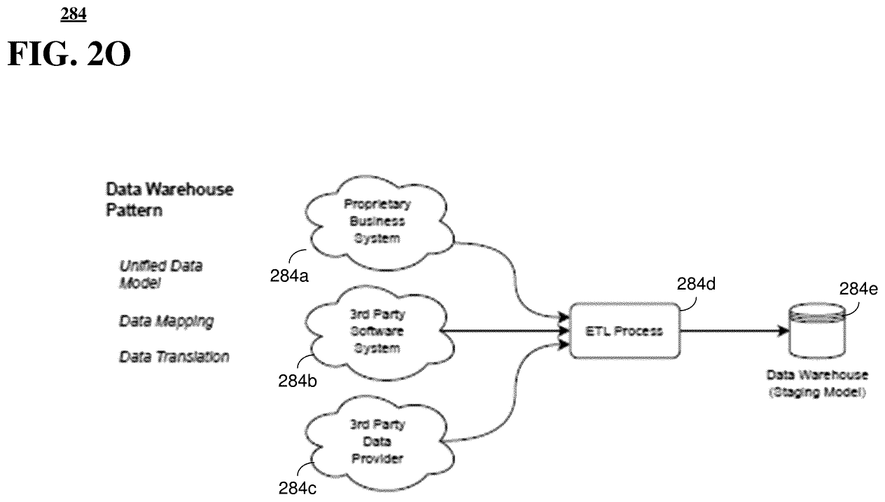

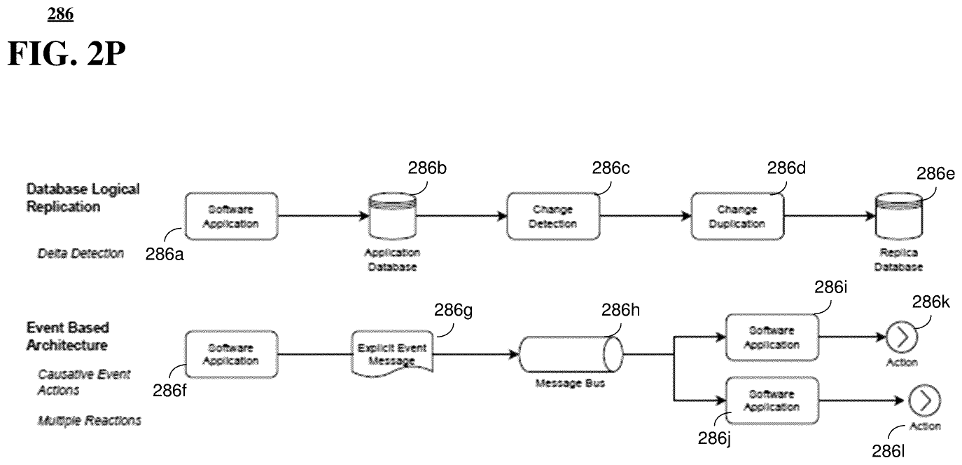

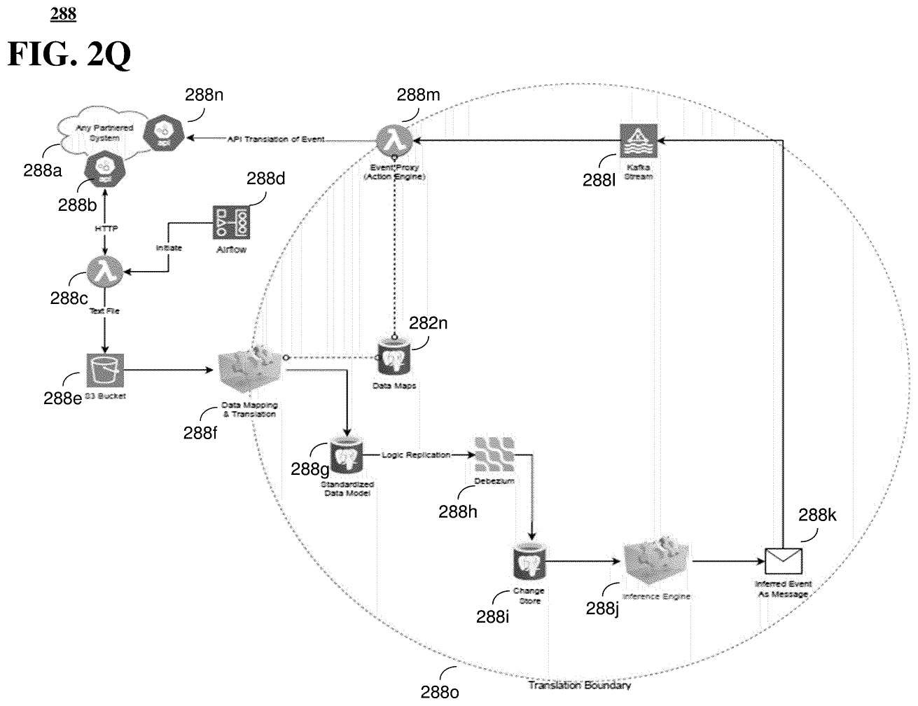

In one or more embodiments, after completing the lease application process utilizing the software application on communication device 100e, the server 100a can process the lease application for approval (details of which are further discussed when describing FIGS. 2A-2H). In some embodiments, the server 100a can determine that user 100g is not approved to rent at rental community 100h but would be approved to rent at rental community 100i. In other embodiments, the server 100a can determine that not only is user 100g approved to rent at rental community 100h but also at rental community 100j. In further embodiments, the server 100a, as part of the software application can provide a map to communication device 100e to display the location of a group of rental communities user 100g is approved to rent.

In one or more embodiments, user 100g is not approved to rent at any rental community but can indicate on the lease application that user 100f can be a guarantor for them. In response, the server 100a can send a notification and link to communication device 100d for user 100f to complete a lease application process as a guarantor for user 100g so that user 100g can be approved to rent from a rental community accordingly. In other embodiments, user 100g can indicate that user 100f is a prospective co-tenant. In response, the server 100a can send a notification and link to communication device 100d for user 100f to complete a lease application process as a co-tenant.

FIGS. 2A-2K depicts illustrative embodiments of methods in accordance with various aspects described herein. Referring to FIG. 2A, method 200 is directed to a lease application process utilizing a software application on a communication device by a user who is an apartment secker. The method 200 can include the user, via the communication device, at 200a, selecting an option to apply for a specific rental community utilizing the software application via an embedded Uniform Resource Locator (URL) within a hosting location associated with the specific rental community and/or unit thereof. Further, the method 200 can include the user, via the communication device, at 200b, generating an account to be stored by a server by directly by entering the following: first name, last name, email address, phone number, and password. In addition, the method 200 can include the user, via the communication device, at 200c, agreeing to terms and privacy policies associated with the service provider for the lease application process utilizing the software application. Also, the method 200 can include the user, via the communication device, at 200d, selecting/changing a unit selection and lease term associated with a rental community. If a unit map is not available, then a list of available units grouped/filtered by unit type can be presented to the user to select. The user can select move-in date to drive availability. Lease term can be selected after the unit is selected.

In one or more embodiments, the method 200 can include the user, via the communication device, at 200c, submitting any additional information or documentation needed for the application. (This can be optional based on the rental community settings within the software application). Such submission of additional information can include collecting social security number and birth date, contact information verification (e.g., self set as default contact method), set default contact method, agree to text notifications, and emergency contact information. Further, the method 200 can include the user, via the communication device, at 200f, communicating the details of identity (ID) verification process and consumer protection. This step can also contain legal notifications, disclosures and consent to the ID and screening process. This needs to be agreed to no matter the workflow/method the user follows. The user must agree to all legal terms within this portion of the lease application process. At this step, the user can opt for the standard lease application process. Following the standard lease application process, the server can gather all the information as dictated by rental community settings within software application. In some embodiments, users following this workflow may not be eligible for pre-approval.

In one or more embodiments, the method 200 can include the user, via the communication device, at 200g, capturing a facial image of the user using a camera coupled to the communication device and transmitting the facial image to the server. Further, the method 200 can include the user, via the communication device, at 200h, verifying the user's identity by submitting digital documents and facial image to a third party server for verification. In addition, the method 200 can include the server, at 200i, requesting credit, eviction history, income verification, resident score, and related services based on the screening criteria associated to the selected rental community by a third party server. Also, the method 200 can include the server, at 200j, receiving a response back associated with credit, eviction history, income verification, resident score screening and related services based on the screening criteria associated with the selected rental community. The server can notify the user (response can be sent via email, but responses can also be sent via the software application and/or text message).

In one or more embodiments, the method 200 can include the user, via the communication device, at 200k, agreeing to all legal requirements associated with the lease application and the selected rental community that includes association language, and third party (e.g., Blue Moon) agreements. Further, the method 200 can include the user, via the communication device, at 200l, agreeing to the rental criteria for the selected rental community. This portion of the lease application process can display a digital version of a rental criteria already in use. The user can review and check that they are in agreement with all defined criteria for the selected rental community. (This portion of the lease application process can be displayed as a series of checkboxes). In addition, the method 200 can include the user, via the communication device, at 200m, associating a guarantor to the lease application (if needed). The user can trigger the start of the guarantor workflow process of the software application by sending an invitation link via email/text to communication device associated with the potential guarantor. For a guarantor, the software application can collect the following information: first name, last name, email address, phone number (phone number is typically only required if the user checks the box listed as notify via text message).

In one or more embodiments, the method 200 can include the user, via the communication device, at 200n, associating co-tenant(s)/occupant(s) to the lease application (if needed). That is, the user can associate all individuals living in the unit outside of themselves. The user can flag all individuals with an age of 18 years or older. (For an affordable property, as dictated by the rental community settings, the user can be prompted for the birthdate of all individuals). For any individual with an age of 18 or older, the user can input a cell phone and/or email address. If needed, the software application can trigger the start of the co-tenant workflow process, thereby sending an invitation link via email/text to the communication device associated with the potential co-tenants that are 18 years old or older. If the user is a co-tenant of an already existing applicant, the user can view and confirm this association utilizing the software application. For this portion of the lease application process, the software application can collect the following information: (1) First Name, Last Name, email address (email is typically only required if the individual is 18 or older); phone number (phone number is typically only required if the user checks the boxes that say 18 or older and/or notify via text messages) (only visible if 18 or older is checked) (include message text box followed by send message button). Further, the method 200 can include the user, via the communication device, at 2000, completing any manual data entry if needed utilizing the software application. Manual gathering of screen data is only needed if the data was not available through API via screening partners. However, other embodiments can include a fully automated screen and lease application process that includes obtaining data pertaining to the apartment seeker from third party sources (Department of Motor Vehicle for apartment secker address). In addition, the method 200 can include the user, via the communication device, at 200p, signing the lease application and rental criteria. Signing can include providing an electronic signature or a wet signature via scanning or screen capture of a signed document. Also, the method 200 can include the user, via the communication device, at 200q, paying a screening fee and/or application fee by rendering payment electronically.

In one or more embodiments, the method 200 can include a server, at 200r, transmitting the signed application to a communication device (e.g., computer) associated with the rental community selected by the user. Further, the method 200 can include a server, at 200s, presenting a response back to the communication device associated with the user on their credit, eviction history, income verification, resident score screening and related services based on the screening criteria associated with the selected rental community. In addition, the software application can notify prospective tenants(s) (response can be sent via email, but also can be sent via app and/or text). If the user fails credit approval, the lease application process can terminate or the user, after being prompted, can select to add another user as a guarantor.

In one or more embodiments, the method 200 can include the server, at 200t, screening (requesting) for criminal history based on the screening criteria associated with the selected rental community. Further, the method 200 can include the server, at 200u, receiving criminal history or a verification of criminal history approval. In addition, the method 200 can include the user, via the communication device, at 200v, receiving a status response for the lease application. Also, the method 200 can include the user, via the communication device, at 200w, receiving a digital completed application that is associated/stored in the account of the user (prospective tenant).

Referring to FIG. 2B, method 210 is directed to a lease application process utilizing a software application on a communication device by a user who is designated as a co-tenant by the apartment seeker/user discussed when describing FIG. 2A. The method 210 can include the user, via a communication device, at 210a, receiving an invitation via text and/or email to complete their portion of the lease application process. Further, the method 210 can include the user, via the communication device, at 210b, generating an account to be stored by a server by directly by entering the following: first name, last name, email address, phone number, and password. In addition, the method 210 can include the user, via the communication device, at 210c, agreeing to terms and privacy policies associated with the service provider for the lease application process utilizing the software application. Also, the method 210 can include the user, via the communication device, at 210d, confirming they are going to be a co-resident with named individual(s) (e.g., apartment seeker discussed when describing FIG. 2A), in named unit, at named property.

The method 210 can include the user, via the communication device, at 210c, communicating the details of ID verification process and consumer protection. This step can also contain legal notifications, disclosures and consent to the ID and screening process. This needs to be agreed to no matter the workflow/method the user follows. The user must agree to all legal terms within this portion of the lease application process. Further, the method 210 can include the user, via the communication device, at 210f, capturing a facial image of the user using a camera coupled to the communication device and transmitting the facial image to the server. Further, the method 210 can include the user, via the communication device, at 210f, verifying the user's identity by submitting digital documents and facial image to a third party server for verification. In addition, the method 210 can include the server, at 210g, requesting credit, eviction history, income verification, resident score, and related services based on the screening criteria associated with the selected rental community by a third party server. Also, the method 210 can include the server, at 210h, receiving a response back associated with credit, eviction history, income verification, resident score screening and related services based on the screening criteria associated with the selected rental community. The server can notify the user (response can be sent via email, but responses can also be sent via the software application and/or text message).

In one or more embodiments, the method 210 can include the user, via the communication device, at 210i, submitting any additional information or documentation needed for the application. (This can be optional based on the rental community settings within the software application). Such submission of additional information can include collecting social security number and birth date, contact information verification (self set as default contact method), set default contact method, agree to text notifications, and emergency contact information. Further, the method 210 can include the user, via the communication device, at 210j, agreeing to all legal requirements associated with the lease application and the selected rental community that includes association language, and third party (e.g., Blue Moon) agreements. Further, the method 210 can include the user, via the communication device, at 210k, agreeing to the rental criteria for the selected rental community. This portion of the lease application process can display a digital version of a rental criteria already in use. The user can review and check that they are in agreement with all defined criteria for the selected rental community. (This portion of the lease application process can be displayed as a series of checkboxes). In addition, the method 210 can include the user, via the communication device, at 210l, associating a guarantor to the lease application (if needed). The user can trigger the start of the guarantor workflow process of the software application by sending an invitation link via email/text to communication device associated with the potential guarantor. For a guarantor, the software application can collect the following information: first name, last name, email address, phone number (phone number is typically only required if the user checks the box listed as notify via text message). The method 210 can include the user, via the communication device, at 210m, adding additional occupants (if needed) and also have the ability to review, but not change, occupants entered by other users.

In one or more embodiments, method 210 can include the user, via the communication device, at 210n, completing any manual data entry, if needed. Further, the method 210 can include the user, via the communication device, at 2100, signing the lease application and rental criteria. Signing can include providing an electronic signature or a wet signature via scanning or screen capture of a signed document. In addition, the method 210 can include the user, via the communication device, at 210p, paying a screening fee and/or application fee by rendering payment electronically. Also, the method 210 can include a server, at 210q, transmitting the signed application to a communication device (e.g., computer) associated with the rental community selected by the user. Further, the method 210 can include a server, at 210r, presenting a response back to the communication device associated with the user on their credit, eviction history, income verification, resident score screening and related services based on the screening criteria associated with the selected rental community. In addition, the software application can notify prospective tenants(s) (response can be sent via email, but also can be sent via app and/or text). If the user fails credit approval, the lease application process can terminate or the user, after being prompted, can select to add another user as a guarantor.

In one or more embodiments, the method 210 can include the server, at 210s, screening (requesting) for criminal history based on the screening criteria associated with the selected rental community. Further, the method 210 can include the server, at 210t, receiving criminal history or a verification of criminal history approval. Further, the method 210 can include the user, via the communication device, at 210u, receiving a status response for the lease application. In addition, method 210 can include the user, via the communication device, at 210v, adding additional steps if needed (possibly adding a guarantor at this stage to meet credit requirements). Also, the method 210 can include the user, via the communication device, at 210w, receiving a digital completed application that is associated/stored in the account of the user (prospective co-tenant). Further, the method 210 can include the user, via the communication device, at 210x, manual entering data and the communication device gathering screen data. This is only needed if the data was not available through API via screening partners. Other embodiments can include a fully automated screen and lease application process.

Referring to FIG. 2C, method 220 is directed to a lease application process utilizing a software application on a communication device by a user who is designated as a co-tenant who is a legal dependent but at least 18 years old by the apartment seeker/user discussed when describing FIG. 2A. The method 220 can include the user, via a communication device, at 220a, receiving an invitation via text and/or email to complete their portion of the lease application process. Further, the method 220 can include the user, via the communication device, at 220b, generating an account to be stored by a server by directly by entering the following: first name, last name, email address, phone number, and password. In addition, the method 220 can include the user, via the communication device, at 220c, agreeing to terms and privacy policies associated with the service provider for the lease application process utilizing the software application. Also, the method 220 can include the user, via the communication device, at 220d, confirming they are going to be a co-resident with named individual(s) (e.g., apartment seeker discussed when describing FIG. 2A), in named unit, at named property.

The method 220 can include the user, via the communication device, at 220c, communicating the details of ID verification process and consumer protection. This step can also contain legal notifications, disclosures and consent to the ID and screening process. This needs to be agreed to no matter the workflow/method the user follows. The user must agree to all legal terms within this portion of the lease application process. Further, the method 220 can include the user, via the communication device, at 220ee, capturing a facial image of the user using a camera coupled to the communication device and transmitting the facial image to the server. Further, the method 220 can include the user, via the communication device, at 220f, verifying the user's identity by submitting digital documents and facial image to a third party server for verification. In addition, the method 220 can include the server, at 220g, requesting credit, eviction history, income verification, resident score, and related services based on the screening criteria associated with the selected rental community by a third party server. Also, the method 220 can include the server, at 220h, receiving a response back associated with credit, eviction history, income verification, resident score screening and related services based on the screening criteria associated with the selected rental community. The server can notify the user (response can be sent via email, but responses can also be sent via the software application and/or text message).

In one or more embodiments, the method 220 can include the user, via the communication device, at 220i, submitting any additional information or documentation needed for the application. (This can be optional based on the rental community settings within the software application). Such submission of additional information can include collecting social security number and birth date, contact information verification (e.g., self set as default contact method), set default contact method, agree to text notifications, and emergency contact information. Further, the method 220 can include the user, via the communication device, at 220j, agreeing to all legal requirements associated with the lease application and the selected rental community that includes association language, and third party (e.g., Blue Moon) agreements. Further, the method 220 can include the user, via the communication device, at 220k, agreeing to the rental criteria for the selected rental community. This portion of the lease application process can display a digital version of a rental criteria already in use. The user can review and check that they are in agreement with all defined criteria for the selected rental community. (This portion of the lease application process can be displayed as a series of checkboxes).

In one or more embodiments, method 220 can include the user, via the communication device, at 220l, completing any manual data entry, if needed. Further, the method 220 can include the user, via the communication device, at 220m, signing the lease application and rental criteria. Signing can include providing an electronic signature or a wet signature via scanning or screen capture of a signed document. In addition, the method 220 can include the user, via the communication device, at 220n, paying a screening fee and application fee by rendering payment electronically. Also, the method 220 can include a server, at 2200, transmitting the signed application to a communication device (e.g., computer) associated with the rental community selected by the user. Further, the method 220 can include a server, at 220p, presenting a response back to the communication device associated with the user on their credit, eviction history, income verification, resident score screening and related services based on the screening criteria associated with the selected rental community. In addition, the software application can notify prospective tenants(s) (response can be sent via email, but also can be sent via app and/or text). If the user fails credit approval, the lease application process can terminate or the user, after being prompted, can select to add another user as a guarantor.

In one or more embodiments, the method 220 can include the server, at 220q, screening (requesting) for criminal history based on the screening criteria associated to the selected rental community. Further, the method 220 can include the server, at 220r, receiving criminal history or a verification of criminal history approval. Further, the method 220 can include the user, via the communication device, at 220s, receiving a status response for the lease application. In addition, method 220 can include the user, via the communication device, at 220t, adding additional steps if needed (possibly adding a Guarantor here to meet credit requirements). Also, the method 220 can include the user, via the communication device, at 220u, receiving a digital completed application, that is associated/stored in the account of the user (prospective co-tenant). Further, the method 220 can include the user, via the communication device, at 220v, manual entering data and the communication device gathering screen data. This is only needed if the data was not available through API via screening partners. Other embodiments can include a fully automated screen and lease application process.

Referring to FIG. 2D, method 230 is directed to a lease application process utilizing a software application on a communication device by a user who is designated as a guarantor by the apartment seeker/user discussed when describing FIG. 2A. The method 230 can include the user, via a communication device, at 230a, receiving an invitation via text and/or email to complete their portion of the lease application process. Further, the method 230 can include the user, via the communication device, at 230b, generating an account to be stored by a server by directly by entering the following: first name, last name, email address, phone number, and password. In addition, the method 230 can include the user, via the communication device, at 230c, agreeing to terms and privacy policies associated with the service provider for the lease application process utilizing the software application. Also, the method 230 can include the user, via the communication device, at 230d, confirming they are going to be a guarantor with named individual(s) (e.g., apartment seeker discussed when describing FIG. 2A), in named unit, at named property.

The method 230 can include the user, via the communication device, at 230c, communicating the details of ID verification process and consumer protection. This step can also contain legal notifications, disclosures and consent to the ID and screening process. This needs to be agreed to no matter the workflow/method the user follows. The user must agree to all legal terms within this portion of the lease application process. Further, the method 230 can include the user, via the communication device, at 230ee, capturing a facial image of the user using a camera coupled to the communication device and transmitting the facial image to the server. Further, the method 230 can include the user, via the communication device, at 230f, verifying the user's identity by submitting digital documents and facial image to a third party server for verification. In addition, the method 230 can include the server, at 230g, requesting credit, eviction history, income verification, resident score, and related services based on the screening criteria associated with the selected rental community by a third party server. Also, the method 230 can include the server, at 230h, receiving a response back associated with credit, eviction history, income verification, resident score screening and related services based on the screening criteria associated with the selected rental community. The server can notify the user (response can be sent via email, but responses can also be sent via the software application and/or text message).

In one or more embodiments, the method 230 can include the user, via the communication device, at 230i, submitting any additional information or documentation needed for the application. (This can be optional based on the rental community settings within the software application). Such submission of additional information can include collecting social security number and birth date, contact information verification (e.g., self set as default contact method), set default contact method, agree to text notifications, and emergency contact information. Further, the method 230 can include the user, via the communication device, at 230j, agreeing to all legal requirements associated with the lease application and the selected rental community that includes association language, and third party (e.g., Blue Moon) agreements. Further, the method 230 can include the user, via the communication device, at 230k, agreeing to the rental criteria for the selected rental community. This portion of the lease application process can display a digital version of a rental criteria already in use. The user can review and check that they are in agreement with all defined criteria for the selected rental community. (This portion of the lease application process can be displayed as a series of checkboxes).

In one or more embodiments, method 230 can include the user, via the communication device, at 230l, completing any manual data entry, if needed. Further, the method 230 can include the user, via the communication device, at 230m, signing the lease application and rental criteria. Signing can include providing an electronic signature or a wet signature via scanning or screen capture of a signed document. In addition, the method 230 can include the user, via the communication device, at 230n, paying a screening fee and application fee by rendering payment electronically. Also, the method 230 can include a server, at 2300, transmitting the signed application to a communication device (e.g., computer) associated with the rental community selected by the user. Further, the method 230 can include a server, at 230p, presenting a response back to the communication device associated with the user on their credit, eviction history, income verification, resident score screening and related services based on the screening criteria associated with the selected rental community. In addition, the software application can notify prospective tenants(s) and/or guarantor(s) (response can be sent via email, but also can be sent via app and/or text).

In one or more embodiments, the method 230 can include the user, via the communication device, at 230q, receiving a status response for the lease application. In addition, method 230 can include the user, via the communication device, at 230r, receiving a digital completed application that is associated/stored in the account of the user (prospective co-tenant). Further, the method 230 can include the user, via the communication device, at 230s, manual entering data and the communication device gathering screen data. This is only needed if the data was not available through API via screening partners. Other embodiments can include a fully automated screen and lease application process.

Referring to FIG. 2E, method 240 is directed to a lease application process utilizing a software application on a communication device by a user who is designated as a prospective tenant. The method 240 can include the user, via a communication device, at 240a, generating an account to be stored by a server by directly by entering the following: first name, last name, email address, phone number, and password. In addition, the method 240 can include the user, via the communication device, at 240b, agreeing to terms and privacy policies associated with the service provider for the lease application process utilizing the software application. Also, the method 240 can include the server, at 240c, requesting credit, eviction history, income verification, resident score, and related services based on the screening criteria associated to the selected rental community by a third party server. Also, the method 240 can include the server, at 240d, receiving a response back associated with credit, eviction history, income verification, resident score screening and related services based on the screening criteria associated with the selected rental community. The server can notify the user (response can be sent via email, but responses can also be sent via the software application and/or text message).

In one or more embodiments, the method 240 can include the user, via the communication device, at 240e, submitting any additional information or documentation needed for the application. (This can be optional based on the rental community settings within the software application). Such submission of additional information can include collecting social security number and birth date, contact information verification (e.g., self set as default contact method), set default contact method, agree to text notifications, and emergency contact information. Further, the method 240 can include the user, via the communication device, at 240f, viewing and selecting a rental community from a list of pre-approved rental communities based on the apartment seeker's screening results and the screening criteria associated to each rental community. In addition, the method 240 can include the user, via the communication device, at 240g, selecting a rental community, a unit and lease term. Also, the method 240 can include the user, via the communication device, at 240h, associating a guarantor to the application (if needed). Further, the method 240 can include the user, via the communication device, at 240i, associating co-tenant(s) to the application (if needed). In some embodiments, the viewing and selecting a rental community from a list of pre-approved communities can be repeated. In other embodiments, the selecting of a unit and lease term can be repeated.

In one or more embodiments, the method 240 can include the user, via the communication device, at 240j, agreeing to all legal requirements associated with the lease application and the selected rental community that includes association language, and third party (e.g., Blue Moon) agreements. Further, the method 240 can include the user, via the communication device, at 240k, agreeing to the rental criteria for the selected rental community. This portion of the lease application process can display a digital version of a rental criteria already in use. The user can review and check that they are in agreement with all defined criteria for the selected rental community. (This portion of the lease application process can be displayed as a series of checkboxes).

In one or more embodiments, method 240 can include the user, via the communication device, at 240l, signing the lease application and rental criteria. Signing can include providing an electronic signature or a wet signature via scanning or screen capture of a signed document. In addition, the method 240 can include the user, via the communication device, at 240m, paying a screening fee and/or application fee by rendering payment electronically. Also, the method 240 can include a server, at 240n, transmitting the signed application to a communication device (e.g., computer) associated with the rental community selected by the user. Further, the method 240 can include a server, at 240o, receiving an approval status of the lease application. In addition, method 240 can include the user, via the communication device, at 240p, adding additional steps if needed (possibly adding a guarantor here to meet credit requirements). Also, the method 240 can include the user, via the communication device, at 240q, receiving a digital completed application, that is associated/stored in the account of the user (prospective co-tenant). Further, the method 240 can include the user, via the communication device, at 240r, manual entering data and the communication device gathering screen data. This is only needed if the data was not available through API via screening partners. Other embodiments can include a fully automated screen and lease application process.

Referring to FIG. 2F, method 250 is directed to a lease application process utilizing a software application on a communication device by a user. The method 250 can include the user, via the communication device, at 250a, receiving notification in the software application and/or via text that their lease is ready to sign. This happens automatically if they are fully approved from the application process or can be triggered by rental community personnel if the application was in need of review. Further, the method 250 can include the user, via the communication device, at 250b, agreeing to all legal requirements associated with the lease and the selected rental community. In addition, the method 250 can include the user, via the communication device, at 250c, reviewing the selected unit and lease term selected in the lease application process. Also, the method 250 can include the user, via the communication device, at 250d, receiving a digital lease packet for review that is pre-populated with data from the rental communities' lease settings.

In one or more embodiments, the method 250 can include the user, via the communication device, at 250e, signing the lease (electronically or a scanned wet signature as described herein). Further, the method 250 can include the server, at 250f sending a signed lease to a communication device associated with the rental community for countersignature by rental community personnel. In addition, the method 250 can include the server, at 250g, notifying the user that they will receive a fully executed lease that is stored within their account after the countersignature and payment of any move-in fees. This can include receipt of a notification of lease signature status of pending payment and countersignature. Also, the method 250 can include the user, via the communication device, at 250h, presenting a pre-move-in checklist/marketplace. From here, the user can be presented ancillary services or marketing options potentially including renter's insurance, moving services, utility sign up, and postal address change submission, or other third party offers.

In one or more embodiments, the method 250 can include the user, via the communication device, at 250i, rendering payment of any move-in dollars required per the lease (deposits, rent, etc.). Further, the method 250 can include the communication device of the rental community, at 250j, receiving a notification of payment and, at 250k, unlocking the lease for countersignature. In addition, the method 250 can include the user, via the communication device, at 250l, receiving a fully executed lease. Also, the method 250 can include the user, via the communication device, at 250m, receiving any further move-in instructions.

Referring to FIG. 2G, method 260 is directed to a lease application process utilizing a software application on a communication device by a rental community property manager. The software application can improve the rental community's business by enabling them to: (1) save money by offloading leasing agent activities to a digital process that is less error prone; (2) greatly simplify their tenant screening process while giving them complete control of the tenant flow drivers (acceptable credit, criminal, eviction, income requirements, resident scores, and acceptable screening questions) while ensuring a standardized decision required by Fair Housing; and (3) provide competitive differentiation by offering a frictionless application and onboarding process that can be done on the apartment seeker's time schedule and from any location. All of this can lead to improved profitability for property managers.

The software application can comprise an intelligent automation solution for the leasing office. The property manager can rely on a smarter, proprietary, and algorithmic tenant screening that is filtered in accordance the rental community's screening requirements. Upon receiving a lease application or signed lease from software application, the rental community can be assured that the digital identity of the applicant is verified. The lease application and consent process can be managed digitally without the need for manual intervention from the rental community in many embodiments. The property manager can be assured that all onboarding requirements are met prior to the completion of the onboarding process by the applicant and that tenant ID has been verified.

In one or more embodiments, the method 260 can include a communication device of a rental community property manager, at 260a, configuring settings for the lease application to be completed by an apartment seeker utilizing the software application. After configuration of settings, rental communities can have little to no interaction with the apartment secker until a lease has been submitted for review and countersignature. Exceptions may include the need to associate guarantors to meet credit requirements and manual gathering of screening information (if the data was not available through API via screening partners). Further, the method 260 can include a communication device of a rental community property manager, at 260b, receiving the lease application. In addition, the method 260 can include a communication device of a rental community property manager, at 260c, reviewing the lease. A lease application that was submitted can be presented to the property manager for viewing for manual review if not fully approved. Also, the method 260 can include a server, at 260d, generating a record to be associated with the applicant within server and corresponding information could be transmitted to third party for further processing. Further, the method 260 can include a communication device of a rental community property manager, at 260c, countersigning (electronically or wet signature as described herein) a fully signed lease. Also, the method 260 can include a server, at 260f, storing a fully executed digital copy of the lease in the account associated with the application record and corresponding information can be transmitted to third parties for further processing. In addition, the method 260 can include a server, at 260g, sending the executed lease packet with move-in instructions to a communication device associated with the application (now resident).

Referring to FIG. 2H, method 270 is directed to a lease application process utilizing a software application on a communication device by a rental community property manager. In one or more embodiments, the method 270 can include a communication device of a rental community property manager, at 270a, configuring settings for the lease application to be completed by an apartment seeker utilizing the software application. This can include payment (e.g., dollar amounts), screening criteria limitations, credit, criminal history, eviction history, income verification, income/rent ratio, resident score, and documentation requirements. Further, the method 270 can include a communication device of a rental community property manager, at 270b, configuring screening criteria. In addition, the method 270 can include a communication device of a rental community property manager, at 270c, adding additional screening questions. Also, the method 270 can include a communication device of a rental community property manager, at 270d, generating the lease package (application).

In one or more embodiments, the method 270 can include a communication device of a rental community property manager, at 270c, configuring default lease settings that can include terms, amounts, and rental criteria. Further, the method 270 can include a communication device of a rental community property manager, at 270f, generating move-in instructions. In addition, the method 270 can include a communication device of a rental community property manager, at 270g, sending fully executed lease to a communication device associated with an applicant.

In one or more embodiments, the server can determine a group of rental communities that a user is approved to rent a unit in based on the lease application approval and current physical address of the user (based on a distance threshold provided by the user). The software application implemented by the server can generate and provide a map of the group of rental communities utilizing a mapping software application (integrated into the lease application software application or a stand-alone mapping software application) to a communication device of the user, which the communication device presents to the user. Based on the processing and memory resources of server, the server can provide the physical address of each of the group of rental communities and the communication device can present a map of the group of rental communities utilizing a mapping software application (integrated into the lease application software application on the communication device or a stand-alone mapping software application).

In one or more embodiments, the verification of the identity of user (e.g., apartment secker/tenant, co-tenant, guarantor, etc.) can be performed, at least in part, by utilizing one or more image recognition techniques in comparing a captured facial image of a user with a stored facial image (e.g., in a public database such as a state motor vehicle/driver's license database). Such image recognition can be performed by a third party server or by the server implementing the software application to facilitate the completion of the lease application. In some embodiments, the server can determine its own memory and processing resources to determine whether to implement image recognition on the captured facial image and the stored facial image or to have a third party server perform such image recognition.

Further, any identity verification of a user can be stored on a blockchain or associated with a non-fungible token (NFT) by the server to provide added security.

Referring to FIG. 2I, in one or more embodiments, method 272 is directed to a lease application process utilizing a software application on a communication device by a rental community property manager, a communication device associated with a user, or server operated by lease application management entity. The method 272, can include a communication device of the user at 272a, selecting to initiate the lease application process via user-generated input into a user interface (UI) for a selected property. In some embodiments, the user can select an “Apply Now” button on a website to initiate the lease application process. Further, the method 272 can include the server, at 272b, performing the identification (ID) verification process of the user. This can include generating an account, having the user agree, via user-generated input, to legal terms (e.g., terms of service), and communicating the identification verification process to the user. In addition, the identification verification process can include the user capturing and sending a facial image of the user to the server. A machine learning (ML) kernel (e.g., engine) can be used to recognize the user's facial image with an image on file or one associated with a government issued ID. Further, the ML kernel can adjust the biometric data model on the facial image over time to allow the system to take into account any changes to facial features of the user. Also, the identification verification process can include the user capturing and sending an image of a government issued ID to the server. In addition, the user can provide, via the UI, responses to identification verification questions provided by the server. In response to receiving the facial image, image of government issued ID, and the responses to the identification verification questions, the server can complete the ID verification process. After which, the server can issue an NFT associated with the user to the user's account and/or create a QR code with logo NFC mobile credential for external use.

In one or more embodiments, the method 272 can include the server, at 272c, screening and building the user profile. This can include requesting and receiving credit history associated with the user, requesting and receiving criminal history associated with the user, and requesting and receiving eviction history associated with the user. Further, the screening and building the user profile can include calculating a score associated with the user willingness to pay based on these histories and the user's income. In addition, the screening and building of the user profile can include requesting and receiving income verification. Also, the screening and building of the user profile can include storing all screening information to the user profile in a database associated with the software application.

In one or more embodiments, the method 272 can include the communication device associated with the user, at 272d, confirming the unit of the selected property via user-generated input. This can include the user reviewing and confirming the unit, rental rate, and lease terms for the selected property/rental community.

In one or more embodiments, the method 272 can include the communication device associated with the user, at 272e, submitting the application to the server. This can include the user associating co-occupants to the application, and associating a guarantor to the application if needed. Further, the submission of the application can include the user, via user-generated input, agreeing to rental criteria for the selected property and include agreeing to the legal requirements for the state, federal, rental community associated, and local municipality. In addition, the submission of the application can include signing the application and the rental criteria, rendering payment for screening/application fee and ID verification fee. Also, the submission of the application can include transmitting the signed application to the communication device associated with the property/rental community and the communication device of the property receiving the signed application. Further, the submission application can include the communication device of the user receiving a status response for the application and presenting it to the user on a display. In addition, the property personnel can take action on the application if needed (this would be when an application does not move into an ideal state). The communication device of the property/rental community, the server, and/or the communication device of the user can all obtain a copy of the completed application.

In one or more embodiments, the method 272, can include the server, at 272f, reviewing the lease and executing it accordingly. This can include the server generating and providing to the communication device of the user a lease for review and facilitating signature based on the predefined property lease settings. Further, the user can sign the lease via user-generated input into the communication device of the user and send it to the server. In addition, the server can send the user-signed lease to the communication device of the property to be countersigned by property personnel. Also, the server can receive the fully executed lease from the communication device of the property. In response, the server can provide the communication device of the user with a move-in checklist or requirement.

Referring to FIG. 2J, in one or more embodiments, method 274 is directed to a lease application process utilizing a software application on a communication device by a rental community property manager, a communication device associated with a user, or server operated by lease application management entity. The method 274 can include a communication device of the user, at 274a, searching for a property/rental community in which to live from a listing service provided by the lease management company. This can include the user reviewing, from a UI, a map of all properties associated with the listing service. Further, the user can select to apply for a property and/or the user creates/logs into an account. In addition, the method 272 can include the server, at 274b, performing the identification (ID) verification process of the user. This can include generating an account, having the user agree, via user-generated input, to legal terms (e.g., terms of service), and communicating the identification verification process to the user. In addition, the identification verification process can include the user capturing and sending a facial image to the server. A machine learning (ML) kernel (e.g., engine) can be used to recognize the user's facial image with an image on file or one associated with a government issued ID. Further, the ML kernel can adjust the biometric data model on the facial image over time to allow the system to take into account any changes to facial features of the user. Also, the identification verification process can include the user capturing and sending an image of a government issued ID to the server. In addition, the user can provide, via the UI, response to identification verification questions provided by the server. In response to receiving the facial image, image of government issued ID, and the responses to the identification verification questions, the server can complete the ID verification process. After which, the server can issue an NFT associated with the user to the user's account and/or create a QR code with logo NFC mobile credential for external use.

In one or more embodiments, the method 274 can include the server, at 274c, screening and building the user profile. This can include requesting and receiving credit history associated with the user, requesting and receiving criminal history associated with the user, and requesting and receiving eviction history associated with the user. Further, the screening and building the user profile can include calculating a score associated with the user willingness to pay based on these histories and the user's income. In addition, the screening and building of the user profile can include requesting and receiving income verification. Also, the screening and building of the user profile can include storing all screening information to the user profile in a database associated with the software application.

In one or more embodiments, the method 274 can include the communication device associated with the user, at 274d, confirming the selected property via user-generated input. This can include the user reviewing and confirming selected property from the list of properties from listing service showing the user's pre-approval status with the property.

In one or more embodiments, the method 274 can include the communication device associated with the user, at 274c, confirming the unit of the selected property via user-generated input. This can include the user reviewing and confirming selected property from the list of properties from listing service showing the user's pre-approval status with the property for the unit.

In one or more embodiments, the method 274 can include the communication device associated with the user, at 274f, submitting the application to the server. This can include the user associating co-occupants to the application, and associating a guarantor to the application if needed. Further, the submission of the application can include the user, via user-generated input, agreeing to rental criteria for the selected property and include agreeing to the legal requirements for the state, federal, rental community associated, and local municipality. In addition, the submission of the application can include signing the application and the rental criteria, and rendering payment for screening/application fee and ID verification fee. Also, the submission of the application can include transmitting the signed application to the communication device associated with the property/rental community and the communication device of the property receiving the signed application. Further, the submission application can include the communication device of the user receiving a status response for the application. In addition, the property personnel can take action on the application if needed (this would be when an application does not move into an ideal state). The communication device of the property, the server, and/or the communication device of the user can all obtain a copy of the completed application.

In one or more embodiments, the method 274, can include the server, at 274g, reviewing the lease and executing it accordingly. This can include the server generating and providing to the communication device of the user a lease for review and signature based on the predefined property lease settings. Further, the user can sign the lease via user-generated input into the communication device of the user and send it to the server. In addition, the server can send the user-signed lease to the communication device of the property to be countersigned by property personnel. Also, the server can receive the fully executed lease from the communication device of the property. In response, the server can provide the communication device of the user with a move-in checklist or requirement.

Referring to FIG. 2K, in one or more embodiments, method 276 is directed to a lease application process utilizing a software application on a communication device by a rental community property manager, a communication device associated with a guarantor/user, or server operated by lease application management entity. The method 276 can include the guarantor/user, at 276a, receiving a notification and an invitation to create an account associated with the server to become a guarantor for a pending applicant's application to the property for the selected unit, desired rental rate and lease term. After which, the communication device of the user implements the software application associated with the leasing application process. Further, the method 276 can include the communication device of the user, at 276b, confirming the request from the application and the property. This can include the user reviewing and confirming acceptance to become a guarantor for the pending applicant's application to the property for the selected unit and desired rental rate and lease term.

In one or more embodiments, the method 276 can include the server, at 276c, performing the identification (ID) verification process of the user. This can include generating an account, having the user agree, via user-generated input, to legal terms (e.g., terms of service), and communicating the identification verification process to the user. In addition, the identification verification process can include the user capturing and sending a facial image to the server. A machine learning (ML) kernel (e.g., engine) can be used to recognize the user's facial image with an image on file or one associated with a government issued ID. Further, the ML kernel can adjust the biometric data model on the facial image over time to allow the system to take into account any changes to facial features of the user. Also, the identification verification process can include the user capturing and sending an image of a government issued ID to the server. In addition, the user can provide, via the UI, response to identification verification questions provided by the server. In response to receiving the facial image, image of government issued ID, and the responses to the identification verification questions, the server can complete the ID verification process. After which, the server can issue an NFT associated with the user to the user's account and/or create a QR code with logo NFC mobile credential for external use.

In one or more embodiments, the method 276 can include the server, at 276d, screening and building the user profile. This can include requesting and receiving credit history associated with the user, requesting and receiving criminal history associated with the user, and requesting and receiving eviction history associated with the user. Further, the screening and building the user profile can include calculating a score associated with the user willingness to pay based on these histories and the user's income. In addition, the screening and building of the user profile can include requesting and receiving income verification. Also, the screening and building of the user profile can include storing all screening information to the user profile in a database associated with the software application.

In one or more embodiments, the method 276 can include the communication device associated with the user, at 276e, submitting the application to the server. Further, the submission of the application can include the user, via user-generated input, agreeing to rental criteria for the selected property and include agreeing to the legal requirements for the state, federal, rental community associated, and local municipality. In addition, the submission of the application can include signing the application and the rental criteria, rendering payment for screening/application fee and ID verification fee (if needed, by the guarantor). Also, the submission of the application can include transmitting the signed application to the communication device associated with the property/rental community and the communication device of the property receiving the signed application. Further, the submission application can include the communication device of the user receiving a status response for the application. In addition, the property personnel can take action on the application if needed (this would be when an application does not move into an ideal state). The communication device of the property, the server, and/or the communication device of the user can all obtain a copy of the completed application.

While for purposes of simplicity of explanation, the respective processes are shown and described as a series of blocks in FIGS. 2A-2K, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein. In some embodiments one or more blocks can be performed in response to one or more blocks. In other embodiments, portion of the methods described in FIGS. 2A-2K can be combined with other portions.

Further, portions of some embodiments can be combined with portions of other embodiments.

FIGS. 2L-2Q are block diagrams illustrating exemplary, non-limiting embodiments of a system in accordance with various aspects described herein. Referring to FIG. 2L, in one or more embodiments, a partnered system 278a, external to the hub 2781, makes data available to the hub. The partnered system 278a can be a computer system that includes a group of communication devices or servers associated with a community property management entity or any other computer system that facilitates the lease application process. The hub 2781 can comprise a group of servers that assist in the gathering of data associated with the applicant of an application for renting/leasing a property associated with the community property management entity and facilitate approval of the application. Further, data 278b acquired from the partnered system 2378a is originally in a format native to the partnered system 278a. Further, a data input module translated the data 278b into a format native to the hub 2781. In addition, the inference engine 278c infers what event 278d must have occurred based upon the observed data. The inference engine 278c can include one or more machine learning models in perform the inference. An example event can include submission of an application for a renting/leasing a property associated with the community property management entity. Also, the action system 278e initiates actions based upon the inferred event 278d, and other contextual information.

In one or more embodiments, an action initiates a process 278f within partnered system 278i using data formats and communication methods native to, and defined in advance by, the individual recipient partnered system 278i. More than one action could be initiated by the same event, and those actions could be directed toward more than one partnered system in various combinations including a new action 278g directed to partnered system 278j or an updated action 278h directed to a partnered system 278k

Referring to FIG. 2M, in one or more embodiments, a partnered system 280a, external to the hub, makes data available to the hub. Methods for access could optionally include: providing one or more hypertext transfer protocol (HTTP)/representation state transfer (REST) application programmable interface (API) endpoints, or an equivalent, for the hub to call for data; pushing data to one or more HTTP/REST API endpoints, or an equivalent, provided by the hub; sending data in structured, or semi-structured, data files via some form of file transfer such as secure file transfer protocol (SFTP); and printing data in reports physically delivered to the hub operator to be scanned and parsed.

In one or more embodiments, data retrievers 280b (e.g., software applications) acquire data from the partnered system 280a via any of the available methods for that system. Further, the data retrievers 280b may actively poll for data, or be passive recipients of data sent to them. Many data retrievers 280b can be software designed to connect to a partner system's API, make a request, and return the provided data. Data retrievers 280b can include manual elements such as file scanning & upload interfaces. In addition, the activities of data retrievers 280b can be managed by an orchestrator software management application 280c. In some embodiments, some partnered systems can have limits to the frequency at which data may be requested. Some inferences can require data from more than one of a partnered system's data access options and coordination may be desired. The need for data retrieval frequency may change based on time, date, demand, or other contextual factors.

In one or more embodiments, a data mapper 280c (e.g., software application) keeps a list of specific data points that can be retrieved from a partnered system and correlates each to an equivalent point on a standardized data model. Data from a partnered system may be labeled with an identifier that is different from the identifier used in the hub for a data point with the same meaning. A partnered system may have a data point stored as a different data type than the hub's standardized model, such as a number stored as text vs being stored as an integer. In some embodiments, a data point may not have a direct equivalent in the standardized data model. A helper software application that includes more complex logic can be needed to make an accurate translation.

In one or more embodiments, a standardized data model 280f for a domain of operation is created to represent the relations of concepts of that domain, and the properties of those concepts, which exist as data points. Various partnered systems can operate in the same business or knowledge domain yet represent it differently in their data models. The standardized model captures the common representations of concepts from all systems, and provides elements that more abstractly represent the uncommonly expressed concepts. Attempting to convert from one partnered system's model to another partnered system's model creates a complex and difficult to maintain mesh of relationships. The model allows each partnered system's proprietary representation to be translated only once. When data from a partnered system is stored structured as the standardized model, it creates a snapshot in time of the partnered system's state.

In one or more embodiments, as the data points in the structured data store are updated, reflecting the new state of objects in the partnered system, a data detection 280g software application detects and records the differences between the old and new object states. These noted changes and, possibly, some of their associated data values can be represented as a change item object 280i.

In one or more embodiments, the inference engine 280h maintains a list of possible causative events, and a pattern of changes in various data objects that each event causes. By comparing Change Item objects 280i to known patterns of changes, the causative event that created the observed pattern (e.g., one or more software patterns) of changes can be inferred. Causative events are usually business operations that have happened, but can be any sort of event for which data is recorded.

In one or more embodiments, once a causative event is detected, one or more actions are determined and initiated by an action engine 280k. Associations between causative events (e.g., in the lease application process), context information (subject matter, specific partner, etc.), and known actions to take are stored here. Standard Actions can be anything desired, but can most often be the sending of a command or sending of a data object. Actions initiated by the action engine 280k itself are carried out by software capable of executing the action, commonly communicated through a sender 2801. A sender 2801 can connect to a given partnered system's methods of access to deliver data objects, commands, files, or whatever else may be required. Most senders 2801 are also able to translate information from the hub's standard format into a partnered system's desired format(s).

Referring to FIG. 2N, system 282 shows exemplary healthcare domain communication software patterns. A software pattern is reusable piece of software that can be used as a solution to a commonly occurring problem in implementing a comprehensive software solution to a technical problem. In one or more embodiments, a software pattern can facilitate a proprietary medical record system 282a can make a HL7 format lab request 282b from a proprietary laboratory system 282s that initiates a running of a test 282d based on the HL7 format lab request 282b. In other embodiments, a software pattern can facilitate a proprietary medical record system receiving multiple HL7 format lab results including a first HL7 lab result 282f and a second HL7 format lab result 282g from a proprietary laboratory system 282c based on running of tests 282d.

Referring to FIG. 2O, system 284 shows exemplary data warehouse patterns implementing functions that include unified data model, data mapping, data translation. The exemplary data warehouse patterns can include a proprietary business system 284a, a third party software system 284b, and a third party data provider each initiating an extraction transform and load (ETL) process 284d to store or access data from the data warehouse 284c.

Referring to FIG. 2P, system 286 shows exemplary data logical replication patterns implemented in an event-based architecture. These patterns can deal with data detection, causative event actions and multiple reactions. In some embodiments, the patterns can include a software application 286a accessed from an application database 286b that performs change detection 286c and/or change duplication 286d as well as stores any resulting data in a replica database 286c. In other embodiments, the patterns can include a software application 286f sending an explicit event message 286g over a message bus 286h that initiates a first software application 286i and a second software application 286j to perform a first action 286k and a second action 286l, respectively.

Referring to FIG. 2Q, system 288 can be an embodiment of system 280 shown in FIG. 2M. A partnered system 288a can provide data to the hub 2880. The data can be provided over an API 288b over an HTTP interface in the form of a text file 288c that is stored in an accessible cloud storage database 288e. Further, the hub's data mapping and translation 288f software applications translates the data from the text file 288c that is a native format of the partnered system 280a into a format of the hub 2880 utilizing a standardized data model 288g. The data mapping and translation can be implemented with data maps 282n stored in a database. A change data capture application 288h can be used to facilitate the translation and store it in a database 288i.

In one or more embodiments, an inference engine 288j can access the data from database 288i can infer an event based on the data. Further, the inference engine 288j can generate the inferred event as a message 288k. The message 288k can be sent to the partnered system 288a utilizing library software applications 2881 and the action engine 288m via an API 288n.

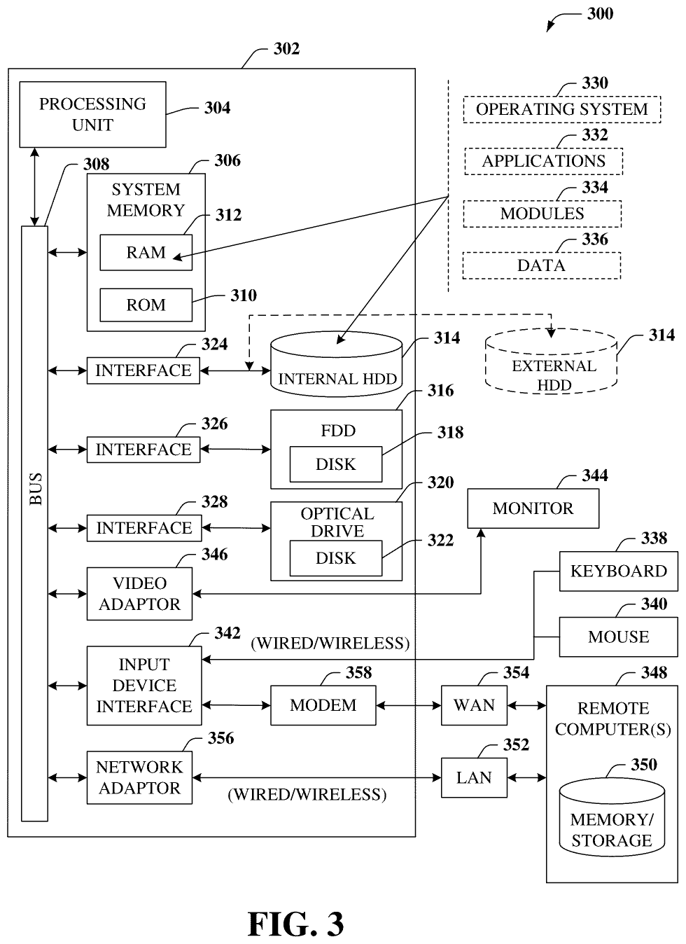

Turning now to FIG. 3, there is illustrated a block diagram of a computing environment in accordance with various aspects described herein. In order to provide additional context for various embodiments of the embodiments described herein, FIG. 3 and the following discussion are intended to provide a brief, general description of a suitable computing environment 300 in which the various embodiments of the subject disclosure can be implemented. In particular, computing environment 300 can be used in the implementation of computing devices described herein. Each of these devices can be implemented via computer-executable instructions that can run on one or more computers, and/or in combination with other program modules and/or as a combination of hardware and software. For example, computing environment 300 can facilitate in whole or in part completion of lease application utilizing a software application and verifying the identity of a prospective tenant. Each of server 100a, server 100c, communication device 100d and communication device 100e can comprise computing environment 300.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 3, the example environment can comprise a computer 302, the computer 302 comprising a processing unit 304, a system memory 306 and a system bus 308. The system bus 308 couples system components including, but not limited to, the system memory 306 to the processing unit 304. The processing unit 304 can be any of various commercially available processors. Dual microprocessors and other multiprocessor architectures can also be employed as the processing unit 304.

The system bus 308 can be any of several types of bus structure that can further interconnect to a memory bus (with or without a memory controller), a peripheral bus, and a local bus using any of a variety of commercially available bus architectures. The system memory 306 comprises ROM 310 and RAM 312. A basic input/output system (BIOS) can be stored in a non-volatile memory such as ROM, erasable programmable read only memory (EPROM), EEPROM, which BIOS contains the basic routines that help to transfer information between elements within the computer 302, such as during startup. The RAM 312 can also comprise a high-speed RAM such as static RAM for caching data.

The computer 302 further comprises an internal hard disk drive (HDD) 314 (e.g., EIDE, SATA), which internal HDD 314 can also be configured for external use in a suitable chassis (not shown), a magnetic floppy disk drive (FDD) 316, (e.g., to read from or write to a removable diskette 318) and an optical disk drive 320, (e.g., reading a CD-ROM disk 322 or, to read from or write to other high-capacity optical media such as the DVD). The HDD 314, magnetic FDD 316 and optical disk drive 320 can be connected to the system bus 308 by a hard disk drive interface 324, a magnetic disk drive interface 326 and an optical drive interface 328, respectively. The hard disk drive interface 324 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 302, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 312, comprising an operating system 330, one or more application programs 332, other program modules 334 and program data 336. All or portions of the operating system, applications, modules, and/or data can also be cached in the RAM 312. The systems and methods described herein can be implemented utilizing various commercially available operating systems or combinations of operating systems.

A user can enter commands and information into the computer 302 through one or more wired/wireless input devices, e.g., a keyboard 338 and a pointing device, such as a mouse 340. Other input devices (not shown) can comprise a microphone, an infrared (IR) remote control, a joystick, a game pad, a stylus pen, touch screen or the like. These and other input devices are often connected to the processing unit 304 through an input device interface 342 that can be coupled to the system bus 308, but can be connected by other interfaces, such as a parallel port, an IEEE 1394 serial port, a game port, a universal serial bus (USB) port, an IR interface, etc.

A monitor 344 or other type of display device can be also connected to the system bus 308 via an interface, such as a video adapter 346. It will also be appreciated that in alternative embodiments, a monitor 344 can also be any display device (e.g., another computer having a display, a smart phone, a tablet computer, etc.) for receiving display information associated with computer 302 via any communication means, including via the Internet and cloud-based networks. In addition to the monitor 344, a computer typically comprises other peripheral output devices (not shown), such as speakers, printers, etc.

The computer 302 can operate in a networked environment using logical connections via wired and/or wireless communications to one or more remote computers, such as a remote computer(s) 348. The remote computer(s) 348 can be a workstation, a server computer, a router, a personal computer, portable computer, microprocessor-based entertainment appliance, a peer device or other common network node, and typically comprises many or all of the elements described relative to the computer 302, although, for purposes of brevity, only a remote memory/storage device 350 is illustrated. The logical connections depicted comprise wired/wireless connectivity to a local area network (LAN) 352 and/or larger networks, e.g., a wide area network (WAN) 354. Such LAN and WAN networking environments are commonplace in offices and companies, and facilitate enterprise-wide computer networks, such as intranets, all of which can connect to a global communications network, e.g., the Internet.

When used in a LAN networking environment, the computer 302 can be connected to the LAN 352 through a wired and/or wireless communication network interface or adapter 356. The adapter 356 can facilitate wired or wireless communication to the LAN 352, which can also comprise a wireless AP disposed thereon for communicating with the adapter 356.

When used in a WAN networking environment, the computer 302 can comprise a modem 358 or can be connected to a communications server on the WAN 354 or has other means for establishing communications over the WAN 354, such as by way of the Internet. The modem 358, which can be internal or external and a wired or wireless device, can be connected to the system bus 308 via the input device interface 342. In a networked environment, program modules depicted relative to the computer 302 or portions thereof, can be stored in the remote memory/storage device 350. It will be appreciated that the network connections shown are examples and other means of establishing a communications link between the computers can be used.

The computer 302 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

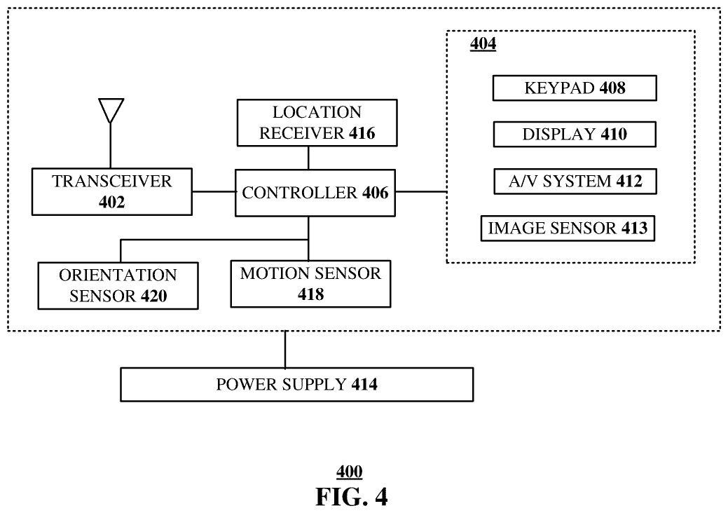

Turning now to FIG. 4, an illustrative embodiment of a communication device 400 is shown. The communication device 400 can serve as an illustrative embodiment of computing devices described herein. For example, communication device 400 can facilitate in whole or in part completion of lease application utilizing a software application and verifying the identity of a prospective tenant. Each of server 100a, server 100c, communication device 100d and communication device 100e can comprise communication device 400.

The communication device 400 can comprise a wireline and/or wireless transceiver 402 (herein transceiver 402), a user interface (UI) 404, a power supply 414, a location receiver 416, a motion sensor 418, an orientation sensor 420, and a controller 406 for managing operations thereof. The transceiver 402 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 402 can also be adapted to support circuit-switched wireline access technologies (such as PSTN), packet-switched wireline access technologies (such as TCP/IP, VoIP, etc.), and combinations thereof.

The UI 404 can include a depressible or touch-sensitive keypad 408 with a navigation mechanism such as a roller ball, a joystick, a mouse, or a navigation disk for manipulating operations of the communication device 400. The keypad 408 can be an integral part of a housing assembly of the communication device 400 or an independent device operably coupled thereto by a tethered wireline interface (such as a USB cable) or a wireless interface supporting for example Bluetooth®. The keypad 408 can represent a numeric keypad commonly used by phones, and/or a QWERTY keypad with alphanumeric keys. The UI 604 can further include a display 410 such as monochrome or color LCD (Liquid Crystal Display), OLED (Organic Light Emitting Diode) or other suitable display technology for conveying images to an end user of the communication device 400. In an embodiment where the display 410 is touch-sensitive, a portion or all of the keypad 408 can be presented by way of the display 410 with navigation features.

The display 410 can use touch screen technology to also serve as a user interface for detecting user input. As a touch screen display, the communication device 400 can be adapted to present a user interface having graphical user interface (GUI) elements that can be selected by a user with a touch of a finger. The display 410 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 410 can be an integral part of the housing assembly of the communication device 400 or an independent device communicatively coupled thereto by a tethered wireline interface (such as a cable) or a wireless interface.

The UI 404 can also include an audio system 412 that utilizes audio technology for conveying low volume audio (such as audio heard in proximity of a human ear) and high-volume audio (such as speakerphone for hands free operation). The audio system 412 can further include a microphone for receiving audible signals of an end user. The audio system 412 can also be used for voice recognition applications. The UI 404 can further include an image sensor 413 such as a charged coupled device (CCD) camera for capturing still or moving images.

The power supply 414 can utilize common power management technologies such as replaceable and rechargeable batteries, supply regulation technologies, and/or charging system technologies for supplying energy to the components of the communication device 400 to facilitate long-range or short-range portable communications. Alternatively, or in combination, the charging system can utilize external power sources such as DC power supplied over a physical interface such as a USB port or other suitable tethering technologies.

The location receiver 416 can utilize location technology such as a global positioning system (GPS) receiver capable of assisted GPS for identifying a location of the communication device 400 based on signals generated by a constellation of GPS satellites, which can be used for facilitating location services such as navigation. The motion sensor 418 can utilize motion sensing technology such as an accelerometer, a gyroscope, or other suitable motion sensing technology to detect motion of the communication device 400 in three-dimensional space. The orientation sensor 620 can utilize orientation sensing technology such as a magnetometer to detect the orientation of the communication device 400 (north, south, west, and east, as well as combined orientations in degrees, minutes, or other suitable orientation metrics).

The communication device 400 can use the transceiver 402 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 406 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 400.

Other components not shown in FIG. 4 can be used in one or more embodiments of the subject disclosure. For instance, the communication device 400 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x= (x₁, x₂, x₃, x₄ . . . xₙ), to a confidence that the input belongs to a class, that is, f (x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
obtaining, over a communication network, first lease application information from a first communication device associated with a user;
determining that the first lease application information includes a first captured facial image of the user;
verifying an identity of the user utilizing image recognition techniques based on the first captured facial image resulting in a first identity verification;
transmitting a first portion of the first lease application information to a first third party server, wherein the first third party server processes the first portion of the first lease application information for application approval;
receiving the application approval from the first third party server;
determining a group of rental communities that the user is approved to lease based on the first lease application information and the application approval; and
transmitting the group of rental communities to the first communication device, wherein the first communication device presents the group of rental communities utilizing a mapping software application.

2. The device of claim 1, wherein the operations comprise storing the first identity verification on a blockchain for security purposes.

3. The device of claim 1, wherein the operations comprise associating a non-fungible token (NFT) with the first identity verification.

4. The device of claim 1, wherein the verifying of the identity of the user comprises:
transmitting, over the communication network, the first captured facial image to a second third party server, wherein the second third party server verifies the identity of the user based on the first captured facial image; and
receiving, over the communication network, the first identity verification from the second third party server.

5. The device of claim 1, wherein the operations comprise:
identifying a guarantor associated with the user based on the first lease application information;
providing, over the communication network, a link to provide second lease application information to a second communication device associated with the guarantor;
obtaining, over the communication network, the second lease application information from the second communication device associated with the guarantor;
determining that the second lease application information includes a second captured facial image of the guarantor;
verifying an identity of the guarantor utilizing image recognition techniques based on the second captured facial image resulting in a second identity verification; and
transmitting a first portion of the second lease application information to the first third party server, wherein the first third party server processes the first portion of the second lease application information for the application approval.

6. The device of claim 1, wherein the operations comprise:
identifying a co-tenant associated with the user based on the first lease application information;
providing, over the communication network, a link to provide third lease application information to a third communication device associated with the co-tenant;
obtaining, over the communication network, the third lease application information from the third communication device associated with the co-tenant;
determining that the third lease application information includes a third captured facial image of the co-tenant;
verifying an identity of the guarantor utilizing image recognition techniques based on the third captured facial image resulting in a third identity verification; and
transmitting a first portion of the third lease application information to the first third party server, wherein the first third party server processes the first portion of the third lease application information for the application approval.

7. A non-transitory machine-readable medium, comprising executable instructions that, when executed by a processing system including a processor, facilitate performance of operations, the operations comprising:
obtaining, over a communication network, first lease application information from a first communication device associated with a user;
determining that the first lease application information includes a first captured facial image of the user;
verifying an identity of the user utilizing image recognition techniques based on the first captured facial image resulting in a first identity verification;
transmitting a first portion of the first lease application information to a first third party server, wherein the first third party server processes the first portion of the first lease application information for application approval;
receiving the application approval from the first third party server;
determining a group of rental communities that the user is approved to lease based on the first lease application information and the application approval; and
transmitting the group of rental communities to the first communication device, wherein the first communication device presents the group of rental communities utilizing a mapping software application.

8. The non-transitory machine-readable medium of claim 7, wherein the operations comprise storing the first identity verification on a blockchain for security purposes.

9. The non-transitory machine-readable medium of claim 7, wherein the operations comprise associating a non-fungible token (NFT) with the first identity verification.

10. The non-transitory machine-readable medium of claim 7, wherein the verifying of the identity of the user comprises:
transmitting, over the communication network, the first captured facial image to a second third party server, wherein the second third party server verifies the identity of the user based on the first captured facial image; and
receiving, over the communication network, the first identity verification from the second third party server.

11. The non-transitory machine-readable medium of claim 7, wherein the operations comprise:
identifying a guarantor associated with the user based on the first lease application information;
providing, over the communication network, a link to provide second lease application information to a second communication device associated with the guarantor;
obtaining, over the communication network, the second lease application information from the second communication device associated with the guarantor;
determining that the second lease application information includes a second captured facial image of the guarantor;
verifying an identity of the guarantor utilizing image recognition techniques based on the second captured facial image resulting in a second identity verification; and
transmitting a first portion of the second lease application information to the first third party server, wherein the first third party server processes the first portion of the second lease application information for the application approval.

12. The non-transitory machine-readable medium of claim 7, wherein the operations comprise:
identifying a co-tenant associated with the user based on the first lease application information;
providing, over the communication network, a link to provide third lease application information to a third communication device associated with the co-tenant;
obtaining, over the communication network, the third lease application information from the third communication device associated with the co-tenant;
determining that the third lease application information includes a third captured facial image of the co-tenant;
verifying an identity of the guarantor utilizing image recognition techniques based on the third captured facial image resulting in a third identity verification; and
transmitting a first portion of the third lease application information to the first third party server, wherein the first third party server processes the first portion of the third lease application information for the application approval.

13. A method, comprising:
obtaining, over a communication network, by a processing system including a processor, first lease application information from a first communication device associated with a user;
determining, by the processing system, that the first lease application information includes a first captured facial image of the user;
verifying, by the processing system, an identity of the user utilizing image recognition techniques based on the first captured facial image resulting in a first identity verification;
transmitting, by the processing system, a first portion of the first lease application information to a first third party server, wherein the first third party server processes the first portion of the first lease application information for application approval;
receiving, by the processing system, the application approval from the first third party server;
determining, by the processing system, a group of rental communities that the user is approved to lease based on the first lease application information and the application approval; and
transmitting, by the processing system, the group of rental communities to the first communication device, wherein the first communication device presents the group of rental communities utilizing a mapping software application.

14. The method of claim 13, comprising storing, by the processing system, the first identity verification on a blockchain for security purposes.

15. The method of claim 13, comprising associating, by the processing system, a non-fungible token (NFT) with the first identity verification.

16. The method of claim 13, wherein the verifying of the identity of the user comprises:
transmitting, over the communication network, by the processing system, the first captured facial image to a second third party server, wherein the second third party server verifies the identity of the user based on the first captured facial image; and
receiving, over the communication network, by the processing system, the first identity verification from the second third party server.

17. The method of claim 13, comprising:
identifying, by the processing system, a guarantor associated with the user based on the first lease application information;
providing, over the communication network, by the processing system, a link to provide second lease application information to a second communication device associated with the guarantor;
obtaining, over the communication network, by the processing system, the second lease application information from the second communication device associated with the guarantor;
determining, by the processing system, that the second lease application information includes a second captured facial image of the guarantor;
verifying, by the processing system, an identity of the guarantor utilizing image recognition techniques based on the second captured facial image resulting in a second identity verification; and
transmitting, by the processing system, a first portion of the second lease application information to the first third party server, wherein the first third party server processes the first portion of the second lease application information for the application approval.

18. The method of claim 13, comprising:
identifying, by the processing system, a co-tenant associated with the user based on the first lease application information;
providing, over the communication network, by the processing system, a link to provide third lease application information to a third communication device associated with the co-tenant;
obtaining, over the communication network, by the processing system, the third lease application information from the third communication device associated with the co-tenant;
determining, by the processing system, that the third lease application information includes a third captured facial image of the co-tenant;
verifying, by the processing system, an identity of the co-tenant utilizing image recognition techniques based on the third captured facial image resulting in a third identity verification; and
transmitting, by the processing system, a first portion of the third lease application information to the first third party server, wherein the first third party server processes the first portion of the third lease application information for the application approval.

19. The method of claim 13, comprising:
screening, by the processing system, the user for the lease application process, wherein the screening comprises:
receiving, by the processing system, a credit history of the user;
receiving, by the processing system, a criminal history of the user;
receiving, by the processing system, an eviction history of the user; and
receiving, by the processing system, income verification.

20. The method of claim 19, comprising:
calculating, by the processing system, a score associated with the user willingness to pay based on the credit history, the criminal history, the eviction history, and the income verification;
receiving, by the processing system, confirmation of unit for a selected property from the communication device of the user;
receiving, by the processing system, application submission from the communication device of the user;
generating, by the processing system, a lease based on the application submission; and
facilitating, by the processing system, execution of the lease between the user and personnel associated with the selected property.
